(19) United States
(12) Patent Application Publication
(10) Pub. No.: US 2023/0003552 A1
(43) Pub. Date: Jan. 5, 2023

(54) ROTATION ANGLE DETECTING DEVICE

(71) Applicant: DENSO CORPORATION, Kariya-city (JP)

(72) Inventor: Yoshinori INUZUKA, Kariya-city (JP)

(21) Appl. No.: 17/940,310

(22) Filed: Sep. 8, 2022

Related U.S. Application Data
(63) Continuation of application No. PCT/JP2021/008804, filed on Mar. 5, 2021.

(30) Foreign Application Priority Data
Mar. 11, 2020 (JP) 2020-042066

(51) Int. Cl. G01D 5/14; G01B 7/30

(52) U.S. Cl. CPC G01D 5/145; G01B 7/30; H02K 11/215

(57) ABSTRACT

A detecting unit outputs a first output value varying with a rotation angle of a rotary body in a first cycle and outputs a second output value varying with the rotation angle in a second cycle. The variation in the second output value is different from the variation in the first output value in a positive/negative sign. A magnitude relationship between the first output value and the second output value changes with variation in the rotation angle at rotation angles during the first cycle. A selector unit selects, from the first output value and the second output value, a value of at least a minimum value and a maximum value of the first output values corresponding to the rotation angles. A computing unit computes, on the basis of the selected value, a value related to the rotation angle.

### CROSS REFERENCE TO RELATED APPLICATION

The present application is a continuation application of International Patent Application No. PCT/JP2021/008804 filed on Mar. 5, 2021, which designated the U.S. and claims the benefit of priority from Japanese Patent Application No. 2020-042066 filed on Mar. 11, 2020. The entire disclosures of all of the above applications are incorporated herein by reference.

### TECHNICAL FIELD

The present disclosure relates to a rotation angle detecting device.

### BACKGROUND

Conventionally, a Hall element that detects a rotation angle of a rotary body has been known.

### SUMMARY

According to an aspect of the present disclosure, a rotation angle detecting device comprises a detecting unit configured to output a first output value that varies with a rotation angle of a rotary body in a first cycle having, as one cycle period, a predetermined range of the rotation angle.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a perspective view of a rotation angle detecting device in a first embodiment;

FIG. 2 is a configuration diagram of the rotation angle detecting device when viewed from II in FIG. 1;

FIG. 3 is a diagram for illustrating a magnetic circuit of the rotation angle detecting device;

FIG. 4 is a configuration diagram of a first sensor of the rotation angle detecting device;

FIG. 5 is a configuration diagram of a second sensor of the rotation angle detecting device;

FIG. 6 is a configuration diagram of a selector unit of the rotation angle detecting device;

FIG. 7 is a relationship diagram among a rotation angle, a magnetic flux, a first output voltage, and a second output voltage;

FIG. 8 is a diagram for illustrating the magnetic circuit when a rotary body rotates;

FIG. 9 is a relationship diagram among the rotation angle, the first output voltage, the second output voltage, and a voltage output to a rotation angle computing unit;

FIG. 10 is a flow chart illustrating processing in a selector unit of a rotation angle detecting device in a second embodiment;

FIG. 11 is a relationship diagram among a rotation angle, a first output voltage, a second output voltage, and a voltage output to a rotation angle computing unit in a rotation angle detecting device in a third embodiment;

FIG. 12 is a relationship diagram among a rotation angle, a first output voltage, a second output voltage, and a voltage output to a rotation angle computing unit in a rotation angle detecting device in a fourth embodiment;

FIG. 13 is a configuration diagram of a rotation angle detecting device in a fifth embodiment;

FIG. 14 is a configuration diagram of a sensor of the rotation angle detecting device in the fifth embodiment;

FIG. 15 is a configuration diagram of a rotation angle detecting device in a sixth embodiment;

FIG. 16 is a configuration diagram of a rotation angle detecting device in a seventh embodiment;

FIG. 17 is a configuration diagram of a rotation angle detecting device in an eighth embodiment;

FIG. 18 is a relationship diagram among a rotation angle, a first output voltage, a second output voltage, and a voltage output to a rotation angle computing unit in a rotation angle detecting device in another embodiment; and

FIG. 19 is a configuration diagram of a selector unit of the rotation angle detecting device in the other embodiment.

### DETAILED DESCRIPTION

Hereinafter, examples of the present disclosure will be described.

According to an example of the present disclosure, a device uses a Hall element to convert a magnetic flux density varying with a rotation angle of a rotary body to a voltage and detect the rotation angle.

According to a study conducted by the present inventors, in the device, in the vicinity of a rotation angle of, e.g., 180 degrees, a voltage varying with the rotation angle switches from a maximum value to zero. In a range in which the voltage switches, a voltage corresponding to a rotation angle before the voltage switches and a voltage corresponding to a rotation angle when the voltage switches exist in duplications, and the rotation angle and the voltage do not have a one-by-one relationship therebetween. Accordingly, by excluding computation of the rotation angle in a predetermined range from the time when the voltage switches and providing a one-by-one relationship between the rotation angle and the voltage, an appropriate rotation angle is computed from the voltage. As a result, such a device has a range in which a rotation angle cannot be detected, and therefore it is impossible to continuously detect the rotation angle.

According to an aspect of the present disclosure, a rotation angle detecting device comprises a detecting unit configured to output a first output value that varies with a rotation angle of a rotary body in a first cycle having, as one cycle period, a predetermined range of the rotation angle and output a second output value that varies with the rotation angle in a second cycle having, as one cycle period, another range of the rotation angle, which is different from that of the first cycle. A variation in the second output value is different from a variation in the first output value in a positive/negative sign. A magnitude relationship between the first output value and the second output value changes with a variation in the rotation angle at a plurality of rotation angles during the one cycle period of the first cycle. The rotation angle detecting device further comprises a selector unit configured to select, from between the first output value and the second output value, a value, which is at least a first threshold corresponding to a minimum value of values of the first output value corresponding to the plurality of rotation angles, and which is at most a second threshold corresponding to a maximum value of the values of the first output value corresponding to the plurality of rotation angles. The rotation angle detecting device further comprises a computing unit configured to compute, based on the value selected by the selector unit, a value related to the rotation angle.

As a result, in a range of at least the first threshold to at most the second threshold, the value output from the detecting unit is continuous at any rotation angle and has a one-by-one relationship with the rotation angle. Accordingly, the value selected by the selector unit is continuous at any rotation angle θ and has a one-by-one relationship with the rotation angle θ. Consequently, the rotation angle is computed on the basis of the value which is continuous at ay rotation angle θ and has the one-by-one relationship with the rotation angle θ, and therefore the rotation angle detecting device can continuously detect the rotation angle.

Referring to the drawings, a description will be given below of embodiments. Note that parts in the following individual embodiments which are the same as or equal to each other are given the same reference signs, and a description thereof is omitted.

### First Embodiment

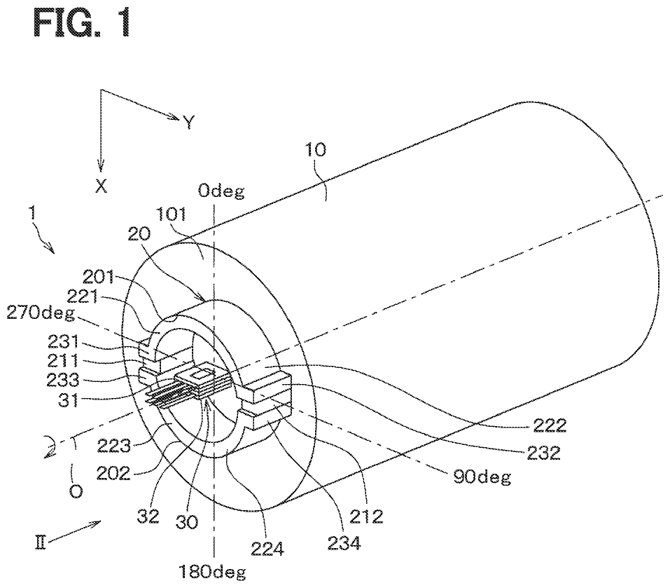

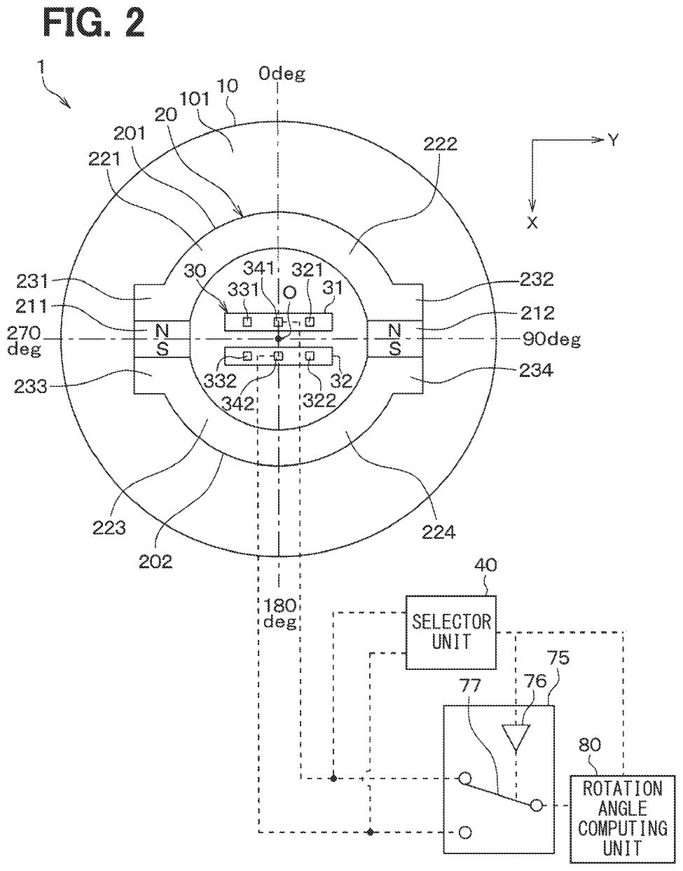

As illustrated in FIGS. 1 and 2, a rotation angle detecting device 1 includes a rotary body 10, a magnetic field generating unit 20, a rotation angle detecting unit 30, a selector unit 40, a switching unit 75, and a rotation angle computing unit 80.

The rotary body 10 is formed to have a cylindrical shape and rotates around an axial line O. For the sake of convenience, a direction perpendicular to the axial line O is hereinbelow referred to as a radial direction.

The magnetic field generating unit 20 is formed to have a barrel shape. The magnetic field generating unit 20 is connected to one end surface 101 of the rotary body 10. In addition, a center axis of the magnetic field generating unit 20 coincides with the axial line O of the rotary body 10. Accordingly, the magnetic field generating unit 20 rotates, together with the rotary body 10, around the axial line O. Additionally, the magnetic field generating unit 20 generates a magnetic field around the rotary body 10. Specifically, the magnetic field generating unit 20 has a first yoke 201, a second yoke 202, a first magnet 211, and a second magnet 212.

The first yoke 201 is formed of a soft magnetic material to have a semi-cylindrical shape. Specifically, the first yoke 201 includes a first arc portion 221, a first extended portion 231, a second arc portion 222, and a second extended portion 232.

The first arc portion 221 is formed to have an arc shape.

The first extended portion 231 is connected to one end of the first arc portion 221. In addition, the first extended portion 231 extends radially outwardly from the one end of the first arc portion 221.

The second arc portion 222 is formed to have an arc shape. In addition, one end of the second arc portion 222 is connected to another end of the first arc portion 221.

The second extended portion 232 is connected to another end of the second arc portion 222. In addition, the second extended portion 232 extends radially outwardly from the other end of the second arc portion 222.

Similarly to the first yoke 201, the second yoke 202 is formed of a soft magnetic material to have a semi-cylindrical shape. Specifically, the second yoke 202 includes a third arc portion 223, a third extended portion 233, a fourth arc portion 224, and a fourth extended portion 234.

The third arc portion 223 is formed to have an arc shape.

The third extended portion 233 is connected to one end of the third arc portion 223. In addition, the third extended portion 233 extends radially outwardly from the one end of the third arc portion 223.

The fourth arc portion 224 is formed to have an arc shape. In addition, one end of the fourth arc portion 224 is connected to another end of the third arc portion 223.

The fourth extended portion 234 is connected to another end of the fourth arc portion 224. In addition, the fourth extended portion 234 extends radially outwardly from the other end of the fourth arc portion 224.

The first magnet 211 is formed of a neodymium magnet or the like to have a plate shape. The first magnet 211 is connected to each of the first extended portion 231 and the third extended portion 233 so as to be interposed between the first extended portion 231 and the third extended portion. In addition, of the first magnet 211, a first yoke 201 side is magnetized herein to an N pole while, of the first magnet 211, a second yoke 202 side is magnetized to an S pole. It may also be possible that the first yoke 201 side of the first magnet 211 is magnetized to the S pole, while the second yoke 202 side of the first magnet 211 is magnetized to the N pole.

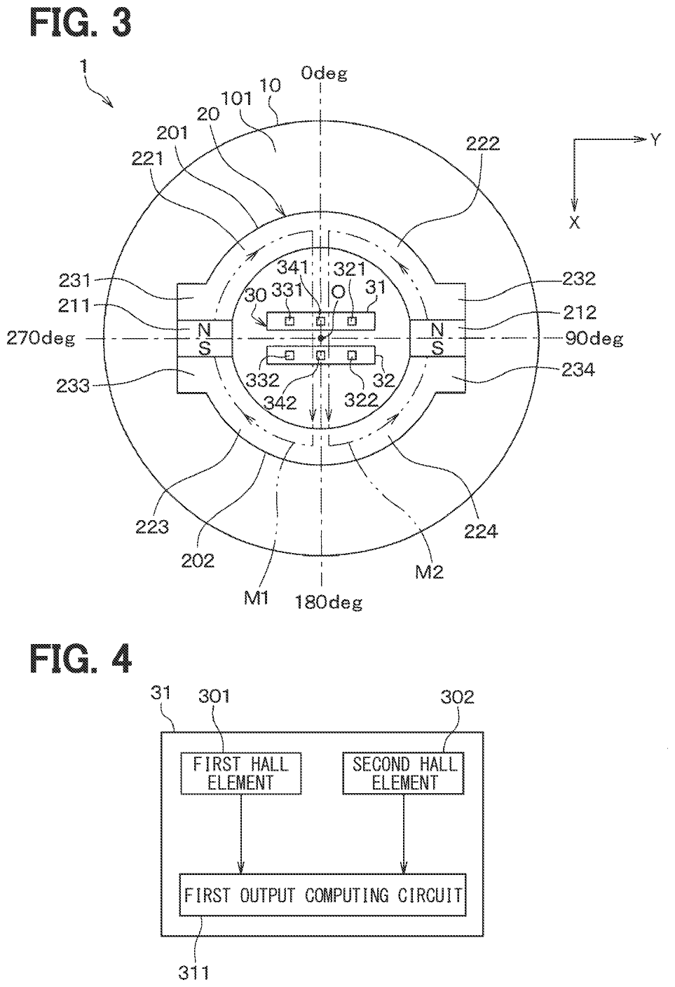

As illustrated in FIG. 3, the first magnet 211 forms a first magnetic circuit M1. The first magnetic circuit M1 includes a magnetic flux flowing from the N pole of the first magnet 211 through the first extended portion 231 and the first arc portion 221. The first magnetic circuit M1 also includes a magnetic flux flowing from a boundary portion between the first arc portion 221 and the second arc portion 222 through the vicinity of the axial line O, a boundary portion between the third arc portion 223 and the fourth arc portion 224, the third arc portion 223, the third extended portion 233, and the S pole of the first magnet 211 in the magnetic field generating unit 20.

The second magnet 212 is formed similarly to the first magnet 211. The second magnet 212 is connected to the second extended portion 232 and the fourth extended portion 234 so as to be interposed between the second extended portion 232 and the fourth extended portion 234. In addition, the second magnet 212 is disposed at a position symmetrical to that of the first magnet 211 with respect to the axial line O. The second magnet 212 is also magnetized similarly to the first magnet 211. Specifically, of the second magnet 212, a first yoke 201 side is magnetized to an N pole while, of the second magnet 212, a second yoke 202 side is magnetized to an S pole.

The second magnet 212 forms a second magnetic circuit M2. The second magnetic circuit M2 includes a magnetic flux flowing from the N pole of the second magnet 212 through the second extended portion 232 and the second arc portion 222. The second magnetic circuit M2 also includes a magnetic flux flowing from the boundary portion between the first arc portion 221 and the second arc portion 222 through the magnetic field generation portion 20 in the vicinity of the axial line O, the boundary portion between the third arc portion 223 and the fourth arc portion 224, the fourth arc portion 224, the fourth extended portion 234, and the S pole of the second magnet 212. Consequently, in the magnetic field generating unit 20 in the vicinity of the axial line O, a magnetic flux resulting from mutual enhancement of the magnetic flux flowing in the first magnetic circuit M1 and the magnetic flux flowing in the second magnetic circuit M2 flows.

The rotation angle detecting unit 30 is disposed in the vicinity of the axial line O in the magnetic field generating unit 20. Accordingly, the magnetic fluxes flowing in the first magnetic circuit M1 and the second magnetic circuit M2 flow in the rotation angle detecting unit 30. The rotation angle detecting unit 30 also outputs, on the basis of the magnetic fluxes flowing in the first magnetic circuit M1 and the second magnetic circuit M2, a signal according to a rotation angle θ of the rotary body 10. Specifically, the rotation angle detecting unit 30 has a first sensor 31 and a second sensor 32.

As illustrated in FIG. 4, the first sensor 31 includes a first Hall element 301, a second Hall element 302, and a first output computing circuit 311. As illustrated in FIG. 2, the first sensor 31 also includes a first power source terminal 321, a first ground terminal 331, and a first output terminal 341. It is assumed herein that one direction perpendicular to the axial line O of the rotary body 10 is an X-direction. It is also assumed that a direction perpendicular to an axial line O direction and the X-direction is a Y-direction.

The first Hall element 301 is a lateral Hall element and outputs a signal according to a magnetic flux flowing in a direction perpendicular to a detection surface not shown, which is a signal according to a magnetic flux flowing in the X-direction with respect to the first sensor 31 herein, to the first output computing circuit 311 described later.

The second Hall element 302 is a vertical Hall element and outputs a signal according to a magnetic flux flowing in a direction parallel to the detection surface not shown, which is a signal according to a magnetic flux flowing in the Y-direction with respect to the first sensor 31, to the first output computing circuit 311.

The first output computing circuit 311 outputs a voltage corresponding to the rotation angle θ of the rotary body 10 on the basis of the signal from the first Hall element 301 and the signal from the second Hall element 302. For the sake of convenience, the output from the first output computing circuit 311 is hereinafter referred to as a first output voltage Vs1. The first output voltage Vs1 corresponds to a first output value and is adjusted to, e.g., 0 to 5 V.

The first power source terminal 321 is connected to a power source not shown. The first ground terminal 331 is connected to the ground not shown. As illustrated in FIG. 2, the first output terminal 341 is connected to the first output computing circuit 311 and to the selector unit 75 and the switching unit 75 each described later. Accordingly, the first output voltage Vs1 as an output from the first output computing circuit 311 is applied to the selector unit 40 and the switching unit 75 each described later.

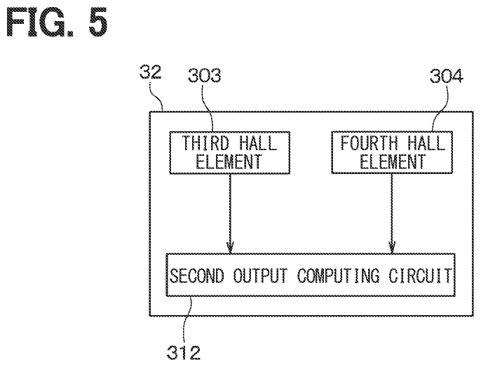

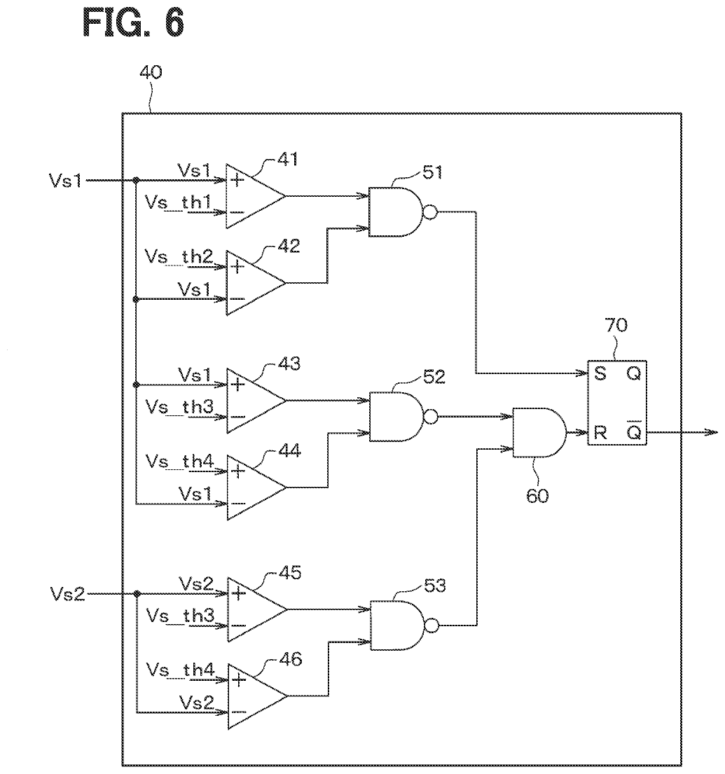

The second sensor 32 is disposed herein so as to face the first sensor 31 in the X-direction. As illustrated in FIG. 5, the second sensor 32 includes a third Hall element 303, a fourth Hall element 304, and a second output computing circuit 312. As illustrated in FIG. 2, the second sensor 32 also includes a second power source terminal 322, a second ground terminal 332, and a second output terminal 342.

Similarly to the first Hall element 301, the third Hall element 303 is a lateral Hall element and outputs a signal according to the magnetic flux flowing in the X-direction with respect to the second sensor 32 to the second output computing circuit 312 described later.

Similarly to the second Hall element 302, the fourth Hall element 304 is a vertical Hall element and outputs a signal according to the magnetic flux flowing in the Y-direction with respect to the second sensor 32 to the second output computing circuit 312 described later.

The second output computing circuit 312 outputs a voltage corresponding to the rotation angle θ of the rotary body 10 on the basis of the signal from the third Hall element 303 and the signal from the fourth Hall element 304. For the sake of convenience, the voltage from the second output computing circuit 312 is hereinafter referred to as a second output voltage Vs2. The second output voltage Vs2 corresponds to the second output value and is adjusted to, e.g., 0 to 5 V, similarly to the first output voltage Vs1.

The second power source terminal 322 is connected to the power source not shown. The second ground terminal 332 is connected to the ground not shown. As illustrated in FIG. 2, the second output terminal 342 is connected to the second output computing circuit 312 and to the selector unit 40 and the switching unit 75 each described above. Accordingly, the second output voltage Vs2 corresponding to an output from the second output computing circuit 312 is applied to the selector unit 40 and the switching unit 75 each described later.

The selector unit 40 selects, as a voltage to be applied to the rotation angle computing unit 80 described later, either one of the first output voltage Vs1 and the second output voltage Vs2. The selector unit 40 also outputs a signal representing the selected voltage to the rotation angle computing unit 80. The selector unit 40 further controls the switching unit 75 described later to cause the selected voltage to be applied to the rotation angle computing unit 80. Specifically, the selector unit 40 is configured to include an analog circuit as a main component, and has a first comparator 41, a second comparator 42, a third comparator 43, a fourth comparator 44, a fifth comparator 45, and a sixth comparator 46. The selector unit 40 also has a first NAND circuit 51, a second NAND circuit 52, a third NAND circuit 53, an AND circuit 60, and an SR latch circuit 70.

To a non-inverting input terminal of the first comparator 41, the first output voltage Vs1 is input. Meanwhile, to an inverting input terminal of the first comparator 41, a first threshold Vs_th1 is input. As a result, the first comparator 41 changes a level of an output signal on the basis of a result of comparing the first output voltage Vs to the first threshold Vs_th1. Note that the first threshold Vs_th1 is set herein to, e.g., 10% to 25% of 5 V as a maximum voltage of each of the first output voltage Vs1 and the second output voltage Vs2, i.e., 0.5 to 1.25 V.

To a non-inverting input terminal of the second comparator 42, a second threshold Vs_th2 is input. Meanwhile, to an inverting input terminal of the second comparator 42, the first output voltage Vs1 is input. As a result, the second comparator 42 changes a level of an output signal on the basis of a result of comparing the first output voltage Vs1 to the second threshold Vs_th2. Note that the second threshold Vs_th2 is set herein to a voltage larger than the first threshold Vs_th1. For example, the second threshold Vs_th2 is set to 75% to 90% of 5 V as the maximum voltage of each of the first output voltage Vs1 and the second output voltage Vs2, i.e., 3.75 to 4.5 V.

To a non-inverting input terminal of the third comparator 43, the first output voltage Vs1 is input. Meanwhile, to an inverting input terminal of the third comparator 43, a third threshold Vs_th3 is input. As a result, the third comparator 43 changes a level of an output signal on the basis of a result of comparing the first output voltage Vs1 to the third threshold Vs_th3. Note that the third threshold Vs_th3 is set herein to a voltage larger than the first threshold Vs_th1 and smaller than a fourth threshold Vs_th4 described later.

To a non-inverting input terminal of the fourth comparator 44, the fourth threshold Vs_th4 is input. Meanwhile, to an inverting input terminal of the fourth comparator 44, the first output voltage Vs1 is input. As a result, the fourth comparator 44 changes a level of an output signal on the basis of a result of comparing the first output voltage Vs1 to the fourth threshold Vs_th4. Note that the fourth threshold Vs_th4 is set herein to a voltage larger than the third threshold Vs_th3 and smaller than the second threshold Vs_th2.

To a non-inverting input terminal of the fifth comparator 45, the second output voltage Vs2 is input. Meanwhile, to an inverting input terminal of the fifth comparator 45, the third threshold Vs_th3 is input. As a result, the fifth comparator 45 changes a level of an output signal on the basis of a result of comparing the second output voltage Vs2 to the third threshold Vs_th3.

To a non-inverting input terminal of the sixth comparator 46, the fourth threshold Vs_th4 is input. Meanwhile, to an inverting input terminal of the sixth comparator 46, the second output voltage Vs2 is input. As a result, the sixth comparator 46 changes a level of an output signal on the basis of a result of comparing the second output voltage Vs2 to the fourth threshold Vs_th4.

The first NAND circuit 51 computes a logical NAND between the signal from the first comparator 41 and the signal from the second comparator 42 to thereby change a level of an output signal.

The second NAND circuit 52 computes a logical NAND between the signal from the third comparator 43 and the signal from the fourth comparator 44 to thereby change a level of an output signal.

The third NAND circuit 31 computes a logical NAND between the signal from the fifth comparator 45 and the signal from the sixth comparator 46 to thereby change a level of an output signal.

The AND circuit 60 computes a logical AND between the signal from the second NAND circuit 52 and the signal from the third NAND circuit 53 to thereby change a level of an output signal.

To an S terminal of the SR latch circuit 70, the signal from the first NAND circuit 51 is input. Meanwhile, to an R terminal of the SR latch circuit 70, the signal from the AND circuit 60 is input. As a result, the SR latch circuit 70 changes a level of an output signal from a Q bar terminal on the basis of the signal from the first NAND circuit 51 and the signal from the AND circuit 60.

As illustrated in FIG. 2, the switching unit 75 is electrically connected to the rotation angle detecting unit 30, the selector unit 40, and the rotation angle computing unit 80. The switching unit 75 switches, on the basis of the signal from the Q bar terminal of the SR latch circuit 70 in the selector unit 40, a voltage to be output to the rotation angle computing unit 80 to either one of the first output voltage Vs1 and the second output voltage Vs2. Specifically, the switching unit 75 has a buffer 76 and a switch 77.

In the buffer 76, the signal from the Q bar terminal of the SR latch circuit 70 is stored.

For example, the switch 77 is an SPDT. The switch 77 switches, on the basis of the signal stored in the buffer 76, the voltage to be output to the rotation angle computing unit 80 to either one of the first output voltage Vs1 and the second output voltage Vs2. Note that the SPDT is an abbreviation of Single-Pole Double-Throw.

For example, the rotation angle computing unit 80 includes a microcomputer as a main component, and includes a CPU, a ROM, a RAM, a flash memory, an I/O, a bus line connecting these components, and the like. The rotation angle computing unit 80 executes a program stored in the ROM to thereby compute the rotation angle θ of the rotary body 10 on the basis of each of the signal from the Q bar terminal of the SR latch circuit 70 and a voltage applied thereto via the switch 77. Each of the ROM, the RAM, and the flash memory is a non-transitory tangible storage medium.

The rotation angle detecting device 1 is thus configured. The rotation angle detecting device 1 can continuously detect the rotation angle θ.

Next, a description will be given of computation of the rotation angle θ by the rotation angle detecting device 1. For the description, a description will be given of the first output voltage Vs1 and the second output voltage Vs2. For the sake of convenience, it is assumed herein that the rotation angle θ in an initial state is zero. It is assumed that a clockwise direction around the axial line O when viewed from II in FIG. 1 is a positive direction of the rotation angle θ. It is assumed herein that a unit of the rotation angle θ is a degree. In the drawing, the degree as the unit of the rotation angle θ is represented by deg. It is assumed that, of the magnetic fluxes flowing in the first magnetic circuit M1 and the second magnetic circuit M2, the magnetic fluxes flowing in the first sensor 31 are first magnetic fluxes ϕ1. Of the first magnetic fluxes ϕ1, the magnetic flux detected by the first sensor 31 is assumed to be a first X-direction magnetic flux ϕx1. Of the first magnetic fluxes ϕ1, the magnetic flux detected by the first sensor 31 is assumed to be a first Y-direction magnetic flux ϕy1. Of the magnetic fluxes flowing in the first magnetic circuit M1 and the second magnetic circuit M2, the magnetic fluxes flowing in the second sensor 32 are assumed to be second magnetic fluxes ϕ2. Of the second magnetic fluxes ϕ2, the magnetic flux detected by the second sensor 32 is assumed to be a second X-direction magnetic flux ϕx2. Of the second X-direction magnetic fluxes ϕ2, the magnetic flux detected by the second sensor 32 is assumed to a second Y-direction magnetic flux ϕy2.

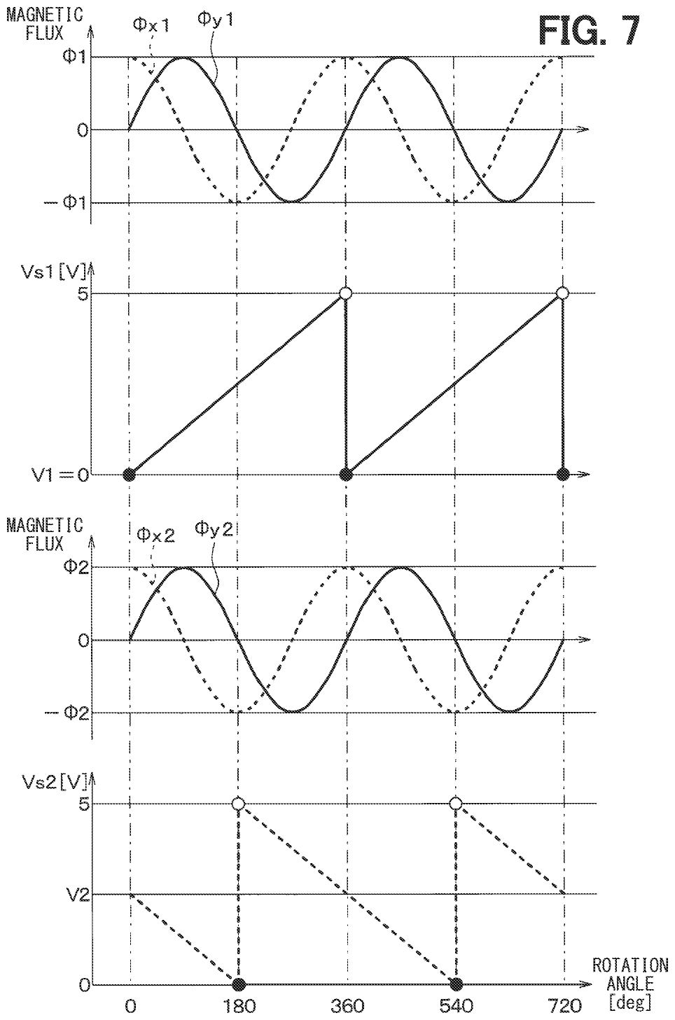

In the initial state, as illustrated in FIG. 2, the first magnet 211 and the second magnet 212 are located on the same straight line extending in the Y-direction across the axial line O. At this time, in the first magnetic circuit M1 and the second magnetic circuit M2, each of the first magnetic fluxes ϕ1 flows only in the X-direction with respect to the first sensor 31, and does not flow in the Y-direction with respect to the first sensor 31. Accordingly, as illustrated in FIG. 7, the first X-direction magnetic flux ϕx1 is the first magnetic flux ϕ1. Meanwhile, the first Y-direction magnetic flux ϕy1 is zero. Also, in the first magnetic circuit M1 and the second magnetic circuit M2, each of the second magnetic fluxes ϕ2 flows only in the X-direction with respect to the second sensor 32, and does not flow in the Y-direction with respect to the second sensor 32. Accordingly, the second X-direction magnetic flux ϕx2 is the second magnetic flux ϕ2. Meanwhile, the second Y-direction magnetic flux ϕy2 is zero.

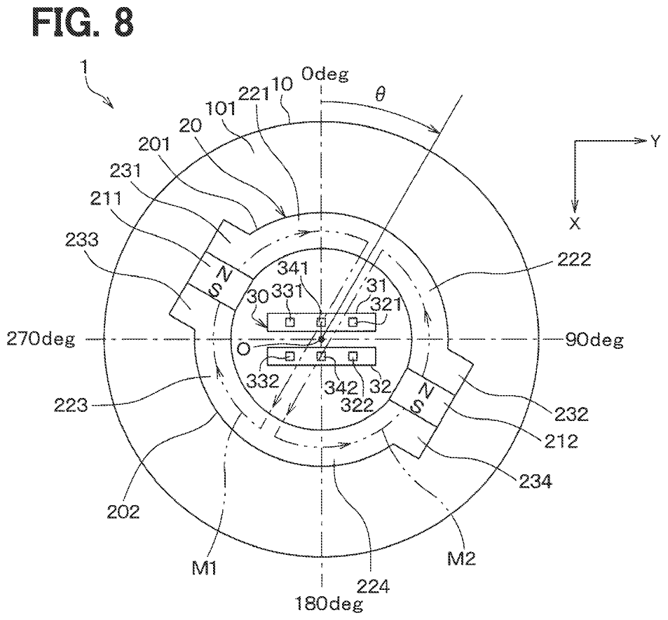

As illustrated in FIG. 8, when the rotary body 10 rotates by the rotation angle θ in the positive direction, the magnetic field generating unit 20 rotates together with the rotary body 10, and consequently the first magnet 211 and the second magnet 212 rotate. At this time, orientations of the first magnetic circuit M1 and the second magnetic circuit M2 change. As a result, in the first magnetic circuit M1 and the second magnetic circuit M2, the first fluxes ϕ1 flow in directions crossing the X-direction and the Y-direction with respect to the first sensor 31. Accordingly, the first X-direction magnetic flux ϕx1 is represented by the first magnetic flux ϕ1 and the rotation angle θ, as shown below in Relational Expression (1-1). In addition, the first Y-direction magnetic flux ϕy1 is represented by the first magnetic flux ϕ1 and the rotation angle θ, as shown below in Relational Expression (1-2). Meanwhile, in the first magnetic circuit M1 and the second magnetic circuit M2, the second fluxes ϕ2 flow in directions crossing the X-direction and the Y-direction with respect to the second sensor 32. Accordingly, the second X-direction magnetic flux ϕx2 is represented by the second magnetic fluxes ϕ2 and the rotation angle θ, as shown below in Relational Expression (2-1). In addition, the second Y-direction magnetic flux ϕy2 is represented by the second magnetic fluxes ϕ2 and the rotation angle θ, as shown below in Relational Expression (2-2). Consequently, each of the first X-direction magnetic flux ϕx1, the first Y-direction magnetic flux ϕy1, the second X-direction magnetic flux ϕx2, the second Y-direction magnetic flux ϕy2 has a triangular waveform, as illustrated in FIG. 7. Note that, in FIG. 7, the first X-direction magnetic flux ϕx1 and the second X-direction magnetic flux ϕx2 are indicated by the broken lines, while the first Y-direction magnetic flux ϕy1 and the second Y-direction magnetic flux ϕy2 are indicated by the solid lines.

ϕx1=ϕ1×cos θ (1-1)

ϕy1=ϕ1×sin θ (1-2)

ϕx2=ϕ2×cos θ (2-1)

ϕy2=ϕ2×sin θ (2-2)

On the basis of the first X-direction magnetic flux ϕx1 and the first Y-direction magnetic flux ϕy1, the first output computing circuit 311 computes the first output voltage Vs1, as shown below in Relational Expression (3-1). In Relational Expression (3-1), K1 is a factor related to the rotation angle θ herein. Here, K1 is set to a positive value, while V1 is a constant. When the rotation angle θ is zero, V1 is set herein such that the first output voltage Vs1 is zero.

Vs=K1×arctan(ϕy1/ϕx1)+V1

=K1×θ+V1 (3-1)

Accordingly, as illustrated in FIG. 7, when the rotation angle θ is zero, the first output voltage Vs1 is zero, and V1 is zero. Meanwhile, since K1 is the positive number, when the rotation angle θ is at least zero and less than 360 degrees, the first output voltage Vs1 increases as the rotation angle θ increases. In addition, the first output voltage Vs1 reaches a maximum value immediately before the rotation angle θ reaches 360 degrees. The first output voltage Vs1 returns to zero when the rotation angle θ reaches 360 degrees. The first output voltage Vs1 is output in a first cycle having, as one cycle period, a range in which the first output voltage Vs1 increases as the rotation angle θ increases, e.g., a range in which the rotation angle θ is at least zero and less than 360. Note that, in FIG. 7, the first output voltage Vs1 is indicated by the solid line.

Thus, the first output computing circuit 311 computes the first output voltage Vs1. The first output computing circuit 311 outputs the computed first output voltage Vs1 to the selector unit 40 and to the switching unit 75.

Likewise, on the basis of the second X-direction magnetic flux ϕx2 and the second Y-direction magnetic flux ϕy2, the second output computing circuit 312 computes the second output voltage Vs2, as shown below in Relational Expression (3-2). In Relational Expression (3-2), K2 is a factor related to the rotation angle θ and is set to a have a positive/negative sign different from that of K1. Accordingly, K2 is set to a negative value. In addition, an absolute value of K2 is set to be same as an absolute value of K1. Moreover, V2 is a constant. When the rogation angle θ is, e.g., 180 degrees, V2 is set such that the second output voltage Vs2 is zero.

Vs2=K2×arctan(ϕy2/ϕx2)+V2

=K2×θ+V2

Therefore, as illustrated in FIG. 7, when the rotation angle θ is zero, the second output voltage Vs2 is V2. In addition, since K2 is a negative number, when the rotation angle θ is at least zero and less than 180 degrees, the second output voltage Vs2 decreases as the rotation angle θ increases. When the rotation angle θ is 180 degrees, the second output voltage Vs2 is zero. Immediately after the rotation angle θ exceeds 180 degrees, the second output voltage Vs2 reaches a maximum value. When the rotation angle θ is larger than 180 degrees and less than 360 degrees, the second output voltage Vs2 decreases as the rotation angle θ increases. When the rotation angle θ reaches 360 degrees, the second output voltage Vs2 returns to V2. When the rotation angle θ is at least 360 degrees and at most 540 degrees, the second output voltage Vs2 decreases as the rotation angle θ increases. The second output voltage Vs2 is output in a second cycle having, as one cycle period, a range in which the second output voltage Vs2 decreases as the rotation angle θ increases, e.g., a range in which the rotation angle θ is more than 180 degrees and at most 540 degrees. Note that the range of the rotation angle θ in the second cycle is different from the range of the rotation angle θ in the first cycle. In addition, in FIG. 7, the second output voltage Vs2 is indicated by the broken line.

Thus, the second output computing circuit 312 computes the second output voltage Vs2. The second output computing circuit 312 also outputs the computed second output voltage Vs2 to the selector unit 40 and to the switching unit 75.

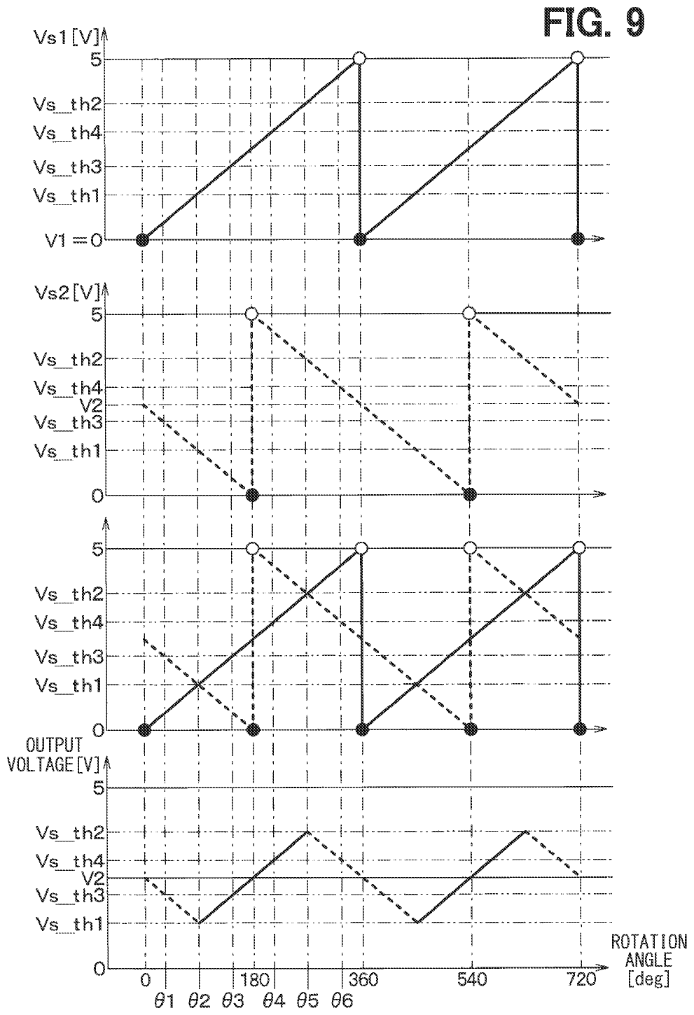

Next, to give a description of the computation of the rotation angle θ, referring to a relationship diagram among the rotation angle θ, the first output voltage Vs1, and the second output voltage Vs2 in FIG. 9, a description will be given of processing in the selector unit 40, the switching unit 75, and the rotation angle computing unit 80. Note that, in FIG. 9, the first output voltage Vs1 is indicated by the solid line, while the second output voltage Vs2 is indicated by the broken line.

In an initial state, the rotation angle θ is zero. At this time, the first output voltage Vs1 is zero. When the first output voltage Vs1 is input to the selector unit 40, since the first output voltage Vs1 is less than the first threshold Vs_th1, the first comparator 41 outputs a low level L signal to the first NAND circuit 51. In addition, since the first output voltage Vs1 is equal to or less than the second threshold Vs_th2, the second comparator 42 outputs a high level H signal to the first NAND circuit 51. As a result, the first NAND circuit 51 outputs the high level H signal to the S terminal of the SR latch circuit 70.

Moreover, since the first output voltage Vs1 is less than the third threshold Vs_th3, the third comparator 43 outputs the low level L signal to the second NAND circuit 52. Furthermore, since the first output voltage Vs1 is equal to or less than the fourth threshold Vs_th4, the fourth comparator 44 outputs the high level H signal to the second NAND circuit 52. As a result, the second NAND circuit 52 outputs the high level H signal to the AND circuit 60.

In the initial state, the second output voltage Vs2 is V2. In addition, V2 is set herein to a voltage larger than the third threshold Vs_th3 and smaller than the fourth threshold Vs_th4. When the second output voltage Vs2 is input to the selector unit 40, since the second output voltage Vs2 is equal to or more than the third threshold Vs_th3, the fifth comparator 45 outputs the high level H signal to the third NAND circuit 53. In addition, since the second output voltage Vs2 is equal to or less than the fourth threshold Vs_th4, the sixth comparator 46 outputs the high level H signal to the third NAND circuit 53. As a result, the third NAND circuit 53 outputs the low level L signal to the AND circuit 60.

Thus, the signals input to the AND circuit 60 are the high level H signal from the second NAND circuit 52 and the low level L signal from the third NAND circuit 53. Accordingly, the AND circuit 60 outputs the low level L signal to the R terminal of the SR latch circuit 70.

Consequently, the signal input to the S terminal of the SR latch is on the high level H, while the signal input to the R terminal of the SR latch circuit 70 is on the low level L. As a result, the SR latch circuit 70 outputs the low level L signal from the Q bar terminal to the switching unit 75 and to the rotation angle computing unit 80.

When receiving the low level L signal from the SR latch circuit 70, the switching unit 75 sets the voltage to be output to the rotation angle computing unit 80 to the second output voltage Vs2. Note that, in FIG. 9, the voltage output from the switching unit 75 to the rotation angle computing unit 80 is stated as the output voltage. Additionally, when the voltage output from the switching unit 75 to the rotation angle computing unit 80 is the first output voltage Vs1, the output voltage is also indicated by the solid line, similarly to the first output voltage Vs1. Moreover, when the voltage output from the switching unit 75 to the rotation angle computing unit 80 is the second output voltage Vs2, the output voltage is indicated by the broken line, similarly to the second output voltage Vs2.

The rotation angle computing unit 80 receives the low level L signal from the SR latch circuit 70. Consequently, the rotation angle computing unit 80 determines that the second output voltage Vs2 is applied to the rotation angle computing unit 80. At this time, as described above, the voltage applied from the switching unit 75 to the rotation angle computing unit 80 is the second output voltage Vs2. Therefore, the rotation angle computing unit 80 computes the rotation angle θ on the basis of the second output voltage Vs2. Specifically, the rotation angle computing unit 80 substitutes K2, V2, and the second output voltage Vs2 applied to the rotation angle computing unit 80 in Relational Expression (3-2) shown above to compute the rotation angle θ.

As a result of rotation of the rotary body 10 from the initial state, the rotation angle θ becomes larger than zero and at most 81. Due to the increased rotation angle θ, the first output voltage Vs1 increases. At this time, the first output voltage Vs1 becomes larger than zero and less than the first threshold Vs_th1. When this first output voltage Vs1 is input to the selector unit 40, since the first output voltage Vs1 is less than the first threshold Vs_th1, the first comparator 41 outputs the low level L signal to the first NAND circuit 51. Additionally, since the first output voltage Vs1 is equal to or less than the second threshold Vs_th2, the second comparator 42 outputs the high level H signal to the first NAND circuit 51. As a result, the first NAND circuit 51 outputs the high level H signal to the S terminal of the SR latch circuit 70.

Additionally, since the first output voltage Vs1 is less than the third threshold Vs_th3, the third comparator 43 outputs the low level L signal to the second NAND circuit 52. Moreover, since the first output voltage Vs1 is equal to or less than the fourth threshold Vs_th4, the fourth comparator 44 outputs the high level H signal to the second NAND circuit 52. As a result, the second NAND circuit 52 outputs the high level H signal to the AND circuit 60.

Meanwhile, due to the increased rotation angle θ, the second output voltage Vs2 decreases. At this time, the second output voltage Vs2 becomes at least the third threshold Vs_th3 and less than the fourth threshold Vs_th4. When the second output voltage Vs2 is input to the selector unit 40, since the second output voltage Vs2 is equal to or more than the third threshold Vs_th3, the fifth comparator 45 outputs the high level H signal to the third NAND circuit 53. Additionally, since the second output voltage Vs2 is equal to or less than the fourth threshold Vs_th4, the sixth comparator 46 outputs the high level H signal to the third NAND circuit 53. As a result, the third NAND circuit 53 outputs the low level L signal to the AND circuit 60.

Thus, the signals input to the AND circuit 60 are the high level H signal from the second NAND circuit 52 and the low level L signal from the third NAND circuit 53. Accordingly, the AND circuit 60 outputs the low level L signal to the R terminal of the SR latch circuit 70.

Consequently, the signal input to the S terminal of the SR latch is on the high level H, while the signal input to the R terminal of the SR latch circuit 70 is on the low level L. As a result, the SR latch circuit 70 outputs the low level L signal from the Q bar terminal to the switching unit 75 and to the rotation angle computing unit 80.

The switching unit 75, which receives the low level L signal from the SR latch circuit 70, leaves the voltage to be output to the rotation angle computing unit 80 at the second output voltage Vs2.

The rotation angle computing unit 80 receives the low level L signal from the SR latch circuit 70. As a result, the rotation angle computing unit 80 determines that the second output voltage is applied to the rotation angle computing unit 80. At this time, as described above, the voltage Vs2 applied from the switching unit 75 to the rotation angle computing unit 80 is the second output voltage Vs2. Therefore, the rotation angle computing unit 80 computes the rotation angle θ on the basis of the second output voltage Vs2. Specifically, the rotation angle computing unit 80 substitutes K2, V2, and the second output voltage Vs2 applied to the rotation angle computing unit 80 in Relational Expression (3-2) shown above to compute the rotation angle θ.

As a result of the rotation of the rotary body 10 from the initial state, the rotation angle θ becomes larger than 81 and less than 82. Due to the increased rotation angle θ, the first output voltage Vs1 increases. At this time, the first output voltage Vs1 becomes larger than zero and less than the first threshold Vs_th1. When the first output voltage Vs1 is input to the selector unit 40, since the first output voltage Vs1 is less than the first threshold Vs_th1, the first comparator 41 outputs the low level L signal to the first NAND circuit 51. In addition, since the first output voltage Vs1 is equal to or less than the second threshold Vs_th2, the second comparator 42 outputs the high level H signal to the first NAND circuit 51. As a result, the first NAND circuit 51 outputs the high level H signal to the S terminal of the SR latch circuit 70.

Additionally, since the first output voltage Vs1 is less than the third threshold Vs_th3, the third comparator 43 outputs the low level L signal to the second NAND circuit 52. Moreover, since the first output voltage Vs1 is equal to or less than the fourth threshold Vs_th4, the fourth comparator 44 outputs the high level H signal to the second NAND circuit 52. As a result, the second NAND circuit 52 outputs the high level H signal to the AND circuit 60.

Meanwhile, due to the increased rotation angle θ, the second output voltage Vs2 decreases. At this time, the second output voltage Vs2 becomes larger than the first threshold Vs_th1 and less than the third threshold Vs_th3. When the second output voltage Vs2 is input to the selector unit 40, since the second output voltage Vs2 is less than the third threshold Vs_th3, the fifth comparator 45 outputs the low level L signal to the third NAND circuit 53. Additionally, since the second output voltage Vs2 is equal to or less than the fourth threshold Vs_th4, the sixth comparator 46 outputs the high level H signal to the third NAND circuit 53. As a result, the third NAND circuit 53 outputs the high level H signal to the AND circuit 60.

Thus, the signals input to the AND circuit 60 are the high level H signal from the second NAND circuit 52 and the high level H signal from the third NAND circuit 53. Accordingly, the AND circuit 60 outputs the high level H signal to the R terminal of the SR latch circuit 70.

Consequently, the signal input to the S terminal of the SR latch is on the high level H, while the signal input to the R terminal of the SR latch circuit 70 is on the high level H. As a result, the SR latch circuit 70 outputs the low level L signal from the Q bar terminal to the switching unit 75 and to the rotation angle computing unit 80.

The switching unit 75, which receives the low level L signal from the SR latch circuit 70, leaves the voltage to be output to the rotation angle computing unit 80 at the second output voltage Vs2.

The rotation angle computing unit 80 receives the low level L signal from the SR latch circuit 70. As a result, the rotation angle computing unit 80 determines that the second output voltage Vs2 is applied to the rotation angle computing unit 80. At this time, as described above, the voltage applied from the switching unit 75 to the rotation angle computing unit 80 is the second output voltage Vs2. Therefore, the rotation angle computing unit 80 computes the rotation angle θ on the basis of the second output voltage Vs2. Specifically, the rotation angle computing unit 80 substitutes K2, V2, and the second output voltage Vs2 applied to the rotation angle computing unit 80 in Relational Expression (3-2) shown above to compute the rotation angle θ.

As a result of the rotation of the rotary body 10 from the initial state, the rotation angle θ becomes at least 82 and less than 83. Due to the increased rotation angle θ, the first output voltage Vs1 increases. At this time, the first output voltage Vs1 becomes at least the first threshold Vs_th1 and less than the third threshold Vs_th3. When the first output voltage Vs1 is input to the selector unit 40, since the first output voltage Vs1 is equal to or more than the first threshold Vs_th1, the first comparator 41 outputs the high level H signal to the first NAND circuit 51. In addition, since the first output voltage Vs1 is equal to or less than the second threshold Vs_th2, the second comparator 42 outputs the high level H signal to the first NAND circuit 51. As a result, the first NAND circuit 51 outputs the low level L signal to the S terminal of the SR latch circuit 70.

Additionally, since the first output voltage Vs1 is less than the third threshold Vs_th3, the third comparator 43 outputs the low level L signal to the second NAND circuit 52. Moreover, since the first output voltage Vs1 is equal to or less than the fourth threshold Vs_th4, the fourth comparator 44 outputs the high level H signal to the second NAND circuit 52. As a result, the second NAND circuit 52 outputs the high level H signal to the AND circuit 60.

Meanwhile, due to the increased rotation angle θ, the second output voltage Vs2 decreases. At this time, the second output voltage Vs2 becomes equal to or less than the first threshold Vs_th1. When the second output voltage Vs2 is input to the selector unit 40, since the second output voltage Vs2 is less than the third threshold Vs_th3, the fifth comparator 45 outputs the low level L signal to the third NAND circuit 53. Additionally, since the second output voltage Vs2 is equal to or less than the fourth threshold Vs_th4, the sixth comparator 46 outputs the high level H signal to the third NAND circuit 53. As a result, the third NAND circuit 53 outputs the high level H signal to the AND circuit 60.

Thus, the signals input to the AND circuit 60 are the high level H signal from the second NAND circuit 52 and the high level H signal from the third NAND circuit 53. Accordingly, the AND circuit 60 outputs the high level H signal to the R terminal of the SR latch circuit 70.

Consequently, the signal input to the S terminal of the SR latch is on the low level L, while the signal input to the R terminal of the SR latch circuit 70 is on the high level H. As a result, the SR latch circuit 70 outputs the high level H signal from the Q bar terminal to the switching unit 75 and to the rotation angle computing unit 80.

The switching unit 75, which receives the high level H signal from the SR latch circuit 70, switches the voltage to be output to the rotation angle computing unit 80 to the first output voltage Vs1.

The rotation angle computing unit 80 receives the high level H signal from the SR latch circuit 70. As a result, the rotation angle computing unit 80 determines that the first output voltage Vs1 is applied to the rotation angle computing unit 80. At this time, as described above, the voltage applied from the switching unit 75 to the rotation angle computing unit 80 is the first output voltage Vs1. Therefore, the rotation angle computing unit 80 computes the rotation angle 8 on the basis of the first output voltage Vs1. Specifically, the rotation angle computing unit 80 substitutes K1, V1, and the first output voltage Vs1 applied to the rotation angle computing unit 80 in Relational Expression (3-1) shown above to compute the rotation angle θ.

As a result of the rotation of the rotary body 10 from the initial state, the rotation angle θ becomes at least 83 and at most 180 degrees. Due to the increased rotation angle θ, the first output voltage Vs1 increases. At this time, the first output voltage Vs1 becomes at least the third threshold Vs_th3 and less than the fourth threshold Vs_th4. When the first output voltage Vs1 is input to the selector unit 40, since the first output voltage Vs1 is equal to or more than the first threshold Vs_th1, the first comparator 41 outputs the high level H signal to the first NAND circuit 51. In addition, since the first output voltage Vs1 is equal to or less than the second threshold Vs_th2, the second comparator 42 outputs the high level H signal to the first NAND circuit 51. As a result, the first NAND circuit 51 outputs the low level L signal to the S terminal of the SR latch circuit 70.

Additionally, since the first output voltage Vs1 is equal to or more than the third threshold Vs_th3, the third comparator 43 outputs the low level L signal to the second NAND circuit 52. Moreover, since the first output voltage Vs1 is equal to or less than the fourth threshold Vs_th4, the fourth comparator 44 outputs the high level H signal to the second NAND circuit 52. As a result, the second NAND circuit 52 outputs the low level L signal to the AND circuit 60.

Meanwhile, due to the increased rotation angle θ, the second output voltage Vs2 decreases. At this time, the second output voltage Vs2 becomes less than the first threshold Vs_th1. When the second output voltage Vs2 is input to the selector unit 40, since the second output voltage Vs2 is less than the third threshold Vs_th3, the fifth comparator 45 outputs the low level L signal to the third NAND circuit 53. Additionally, since the second output voltage Vs2 is equal to or less than the fourth threshold Vs_th4, the sixth comparator 46 outputs the high level H signal to the third NAND circuit 53. As a result, the third NAND circuit 53 outputs the high level H signal to the AND circuit 60.

Thus, the signals input to the AND circuit 60 are the low level L signal from the second NAND circuit 52 and the high level H signal from the third NAND circuit 53. Accordingly, the AND circuit 60 outputs the low level L signal to the R terminal of the SR latch circuit 70.

Consequently, the signal input to the S terminal of the SR latch is on the low level L, while the signal input to the R terminal of the SR latch circuit 70 is on the low level L. As a result, the SR latch circuit 70 holds the previous state. Since the previous signal in the SR latch circuit 70 is on the high level H, the SR latch circuit 70 outputs the high level H signal from the Q bar terminal to the switching unit 75 and to the rotation angle computing unit 80.

The switching unit 75, which receives the high level H signal from the SR latch circuit 70, leaves the voltage to be output to the rotation angle computing unit 80 at the first output voltage Vs1.

The rotation angle computing unit 80 receives the high level H signal from the SR latch circuit 70. As a result, the rotation angle computing unit 80 determines that the first output voltage Vs1 is applied to the rotation angle computing unit 80. At this time, as described above, the voltage applied from the switching unit 75 to the rotation angle computing unit 80 is the first output voltage Vs1. Therefore, the rotation angle computing unit 80 computes the rotation angle θ on the basis of the first output voltage Vs1. Specifically, the rotation angle computing unit 80 substitutes K1, V1, and the first output voltage Vs1 applied to the rotation angle computing unit 80 in Relational Expression (3-1) shown above to compute the rotation angle θ.

In a case where the rotation angle θ exceeds 180 degrees, when switching from zero to a maximum value, the second output voltage Vs2 may have a momentary value which is at least the first threshold Vs_th1 and less than the third threshold Vs_th3. When the second output voltage Vs2 is input to the selector unit 40, since the second output voltage Vs2 is less than the third threshold Vs_th3, the fifth comparator 45 outputs the low level L signal to the third NAND circuit 53. In addition, since the second output voltage Vs2 is equal to or less than the fourth threshold Vs_th4, the sixth comparator 46 outputs the high level H signal to the third NAND circuit 53. As a result, the third NAND circuit 53 outputs the high level H signal to the AND circuit 60.

Immediately after the rotation angle θ exceeds 180 degrees, the first output voltage Vs1 is larger than the third threshold Vs_th3 and less than the fourth threshold Vs_th4. Accordingly, in the same manner as described above, the signal from the second NAND circuit 52 is on the low level L.

Thus, the signals input to the AND circuit 60 are the low level L signal from the second NAND circuit 52 and the high level H signal from the third NAND circuit 53. Accordingly, the AND circuit 60 outputs the low level L signal to the R terminal of the SR latch circuit 70.

Consequently, the signal input to the S terminal of the SR latch is on the low level L, while the signal input to the R terminal of the SR latch circuit 70 is on the low level L. As a result, the SR latch circuit 70 holds the previous state. Since the previous signal in the SR latch circuit 70 is on the high level H, the SR latch circuit 70 outputs the high level H signal from the Q bar terminal to the switching unit 75 and to the rotation angle computing unit 80.

The switching unit 75, which receives the high level H signal from the SR latch circuit 70, leaves the voltage to be output to the rotation angle computing unit 80 at the first output voltage Vs1.

The rotation angle computing unit 80 receives the high level H signal from the SR latch circuit 70. As a result, the rotation angle computing unit 80 determines that the first output voltage Vs1 is applied to the rotation angle computing unit 80. At this time, as described above, the voltage applied from the switching unit 75 to the rotation angle computing unit 80 is the first output voltage Vs1. Therefore, the rotation angle computing unit 80 computes the rotation angle θ on the basis of the first output voltage Vs1. Specifically, the rotation angle computing unit 80 substitutes K1, V1, and the first output voltage Vs1 applied to the rotation angle computing unit 80 in Relational Expression (3-1) shown above to compute the rotation angle θ.

In a case where the rotation angle θ exceeds 180 degrees, when switching from zero to the maximum value, the second output voltage Vs2 may have a momentary value which is at least the third threshold Vs_th3 and at most the fourth threshold Vs_th4. When the second output voltage Vs2 is input to the selector unit 40, since the second output voltage Vs2 is equal to or more than the third threshold Vs_th3, the fifth comparator 45 outputs the high level H signal to the third NAND circuit 53. In addition, since the second output voltage Vs2 is equal to or less than the fourth threshold Vs_th2, the sixth comparator 46 outputs the high level H signal to the third NAND circuit 53. As a result, the third NAND circuit 53 outputs the low level L signal to the AND circuit 60.

Immediately after the rotation angle θ exceeds 180 degrees, the first output voltage Vs1 is larger than the third threshold Vs_th3 and less than the fourth threshold Vs_th4. Accordingly, in the same manner as described above, the signal from the second NAND circuit 52 is on the low level L.

Thus, the signals input to the AND circuit 60 are the low level L signal from the second NAND circuit 52 and the low level L signal from the third NAND circuit 53. Therefore, the AND circuit 60 outputs the low level L signal to the R terminal of the SR latch circuit 70.

Consequently, the signal input to the S terminal of the SR latch is on the low level L, while the signal input to the R terminal of the SR latch circuit 70 is on the low level L. As a result, the SR latch circuit 70 holds the previous state. Since the previous signal in the SR latch circuit 70 is on the high level H, the SR latch circuit 70 outputs the high level H signal from the Q bar terminal to the switching unit 75 and to the rotation angle computing unit 80.

The switching unit 75, which receives the high level H signal from the SR latch circuit 70, leaves the voltage to be output to the rotation angle computing unit 80 at the first output voltage Vs1.

The rotation angle computing unit 80 receives the high level H signal from the SR latch circuit 70. As a result, the rotation angle computing unit 80 determines that the first output voltage Vs1 is applied to the rotation angle computing unit 80. At this time, as described above, the voltage applied from the switching unit 75 to the rotation angle computing unit 80 is the first output voltage Vs1. Therefore, the rotation angle computing unit 80 computes the rotation angle θ on the basis of the first output voltage Vs1. Specifically, the rotation angle computing unit 80 substitutes K1, V1, and the first output voltage Vs1 applied to the rotation angle computing unit 80 in Relational Expression (3-1) shown above to compute the rotation angle θ.

In a case where the rotation angle θ exceeds 180 degrees, when switching from zero to the maximum value, the second output voltage Vs2 may have a momentary value which is more than the fourth threshold Vs_th4 and at most the second threshold Vs_th2. When the second output voltage Vs2 is input to the selector unit 40, since the second output voltage Vs2 is equal to or more than the third threshold Vs_th3, the fifth comparator 45 outputs the high level H signal to the third NAND circuit 53. In addition, since the second output voltage Vs2 is larger than the fourth threshold Vs_th4, the sixth comparator 46 outputs the low level L signal to the third NAND circuit 53. As a result, the third NAND circuit 53 outputs the high level H signal to the AND circuit 60.

Immediately after the rotation angle θ exceeds 180 degrees, the first output voltage Vs1 is larger than the third threshold Vs_th3 and less than the fourth threshold Vs_th4. Accordingly, in the same manner as described above, the signal from the second NAND circuit 52 is on the low level L.

Thus, in the same manner as described above, the signals input to the AND circuit 60 are the low level L signal from the second NAND circuit 52 and the high level H signal from the third NAND circuit 53. Accordingly, the AND circuit 60 outputs the low level L signal to the R terminal of the SR latch circuit 70.

Consequently, in the same manner as described above, the signal input to the S terminal of the SR latch is on the low level L, while the signal input to the R terminal of the SR latch circuit 70 is on the low level L. As a result, the SR latch circuit 70 holds the previous state. Since the previous signal in the SR latch circuit 70 is on the high level H, the SR latch circuit 70 outputs the high level H signal from the Q bar terminal to the switching unit 75 and to the rotation angle computing unit 80.

The switching unit 75, which receives the high level H signal from the SR latch circuit 70, leaves the voltage to be output to the rotation angle computing unit 80 at the first output voltage Vs1.

The rotation angle computing unit 80 receives the high level H signal from the SR latch circuit 70. As a result, the rotation angle computing unit 80 determines that the first output voltage Vs1 is applied to the rotation angle computing unit 80. At this time, as described above, the voltage applied from the switching unit 75 to the rotation angle computing unit 80 is the first output voltage Vs1. Therefore, the rotation angle computing unit 80 computes the rotation angle θ on the basis of the first output voltage Vs1. Specifically, the rotation angle computing unit 80 substitutes K1, V1, and the first output voltage Vs1 applied to the rotation angle computing unit 80 in Relational Expression (3-1) shown above to compute the rotation angle θ.

As a result of the rotation of the rotary body 10 from the initial state, the rotation angle θ becomes larger than 180 degrees and at most 84. Due to the increased rotation angle θ, the first output voltage Vs1 increases. At this time, the first output voltage Vs1 is larger than the third threshold Vs_th3 and at most the fourth threshold Vs_th4. When the first output voltage Vs1 is input to the selector unit 40, since the first output voltage Vs1 is equal to or more than the first threshold Vs_th1, the first comparator 41 outputs the high level H signal to the first NAND circuit 51. In addition, since the first output voltage Vs1 is equal to or less than the second threshold Vs_th2, the second comparator 42 outputs the high level H signal to the first NAND circuit 51. As a result, the first NAND circuit 51 outputs the low level L signal to the S terminal of the SR latch circuit 70.

Additionally, since the first output voltage Vs1 is equal to or more than the third threshold Vs_th3, the third comparator 43 outputs the low level L signal to the second NAND circuit 52. Moreover, since the first output voltage Vs1 is equal to or less than the fourth threshold Vs_th4, the fourth comparator 44 outputs the high level H signal to the second NAND circuit 52. As a result, the second NAND circuit 52 outputs the low level L signal to the AND circuit 60.

Immediately after the rotation angle θ exceeds 180 degrees, the second output voltage Vs2 reaches the maximum value. As the rotation angle θ further increases, the second output voltage Vs2 decreases. At this time, the second output voltage Vs2 becomes larger than the second threshold Vs_th2. When the second output voltage Vs2 is input to the selector unit 40, since the second output voltage Vs2 is equal to or more than the third threshold Vs_th3, the fifth comparator 45 outputs the high level H signal to the third NAND circuit 53. In addition, since the second output voltage Vs2 is larger than the fourth threshold Vs_th4, the sixth comparator 46 outputs the low level L signal to the third NAND circuit 53. As a result, the third NAND circuit 53 outputs the high level H signal to the AND circuit 60.

Thus, the signals input to the AND circuit 60 are the low level L signal from the second NAND circuit 52 and the high level H signal from the third NAND circuit 53. Accordingly, the AND circuit 60 outputs the low level L signal to the R terminal of the SR latch circuit 70.

Consequently, the signal input to the S terminal of the SR latch is on the low level L, while the signal input to the R terminal of the SR latch circuit 70 is on the low level L. As a result, the SR latch circuit 70 holds the previous state. Since the previous signal in the SR latch circuit 70 is on the high level H, the SR latch circuit 70 outputs the high level H signal from the Q bar terminal to the switching unit 75 and to the rotation angle computing unit 80.

The switching unit 75, which receives the high level H signal from the SR latch circuit 70, leaves the voltage to be output to the rotation angle computing unit 80 at the first output voltage Vs1.

The rotation angle computing unit 80 receives the high level H signal from the SR latch circuit 70. As a result, the rotation angle computing unit 80 determines that the first output voltage Vs1 is applied to the rotation angle computing unit 80. At this time, as described above, the voltage applied from the switching unit 75 to the rotation angle computing unit 80 is the first output voltage Vs1. Therefore, the rotation angle computing unit 80 computes the rotation angle θ on the basis of the first output voltage Vs1. Specifically, the rotation angle computing unit 80 substitutes K1, V1, and the first output voltage Vs1 applied to the rotation angle computing unit 80 in Relational Expression (3-1) shown above to compute the rotation angle θ.

Then, as a result of the rotation of the rotary body 10 from the initial state, the rotation angle θ becomes larger then 84 and at most 85. Due to the increased rotation angle θ, the first output voltage Vs1 increases. At this time, the first output voltage Vs1 becomes larger than the fourth threshold Vs_th4 and at most the second threshold Vs_th2. When the first output voltage Vs1 is input to the selector unit 40, since the first output voltage Vs1 is equal to or more than the first threshold Vs_th1, the first comparator 41 outputs the high level H signal to the first NAND circuit 51. In addition, since the first output voltage Vs1 is equal to or less than the second threshold Vs_th2, the second comparator 42 outputs the high level H signal to the first NAND circuit 51. As a result, the first NAND circuit 51 outputs the low level L signal to the S terminal of the SR latch circuit 70.

Additionally, since the first output voltage Vs1 is equal to or more than the third threshold Vs_th3, the third comparator 43 outputs the low level L signal to the second NAND circuit 52. Moreover, since the first output voltage Vs1 is equal to or less than the fourth threshold Vs_th4, the fourth comparator 44 outputs the high level H signal to the second NAND circuit 52. As a result, the second NAND circuit 52 outputs the low level L signal to the AND circuit 60.

Meanwhile, due to the increased rotation angle θ, the second output voltage Vs decreases. At this time, the second output voltage Vs2 becomes equal to or more than the second threshold Vs_th2. When the second output voltage Vs2 is input to the selector unit 40, since the second output voltage Vs2 is equal to or more than the third threshold Vs_th3, the fifth comparator 45 outputs the high level H signal to the third NAND circuit 53. Additionally, since the second output voltage Vs2 is larger than the fourth threshold Vs_th4, the sixth comparator 46 outputs the low level L signal to the third NAND circuit 53. As a result, the third NAND circuit 53 outputs the high level H signal to the AND circuit 60.

Thus, the signals input to the AND circuit 60 are the high level H signal from the second NAND circuit 52 and the high level H signal from the third NAND circuit 53. Accordingly, the AND circuit 60 outputs the high level H signal to the R terminal of the SR latch circuit 70.

Consequently, the signal input to the S terminal of the SR latch is on the low level L, while the signal input to the R terminal of the SR latch circuit 70 is on the high level H. As a result, the SR latch circuit 70 outputs the high level H signal from the Q bar terminal to the switching unit 75 and to the rotation angle computing unit 80.

The switching unit 75, which receives the high level H signal from the SR latch circuit 70, leaves the voltage to be output to the rotation angle computing unit 80 at the first output voltage Vs1.

The rotation angle computing unit 80 receives the high level H signal from the SR latch circuit 70. As a result, the rotation angle computing unit 80 determines that the first output voltage Vs1 is applied to the rotation angle computing unit 80. At this time, as described above, the voltage applied from the switching unit 75 to the rotation angle computing unit 80 is the first output voltage Vs1. Therefore, the rotation angle computing unit 80 computes the rotation angle θ on the basis of the first output voltage Vs1. Specifically, the rotation angle computing unit 80 substitutes K1, V1, and the first output voltage Vs1 applied to the rotation angle computing unit 80 in Relational Expression (3-1) shown above to compute the rotation angle θ.

As a result of the rotation of the rotary body 10 from the initial state, the rotation angle θ becomes larger than 85 and less than 86. Due to the increased rotation angle θ, the first output voltage Vs1 increases. At this time, the first output voltage Vs1 becomes larger than the second threshold Vs_th2. When the first output voltage Vs1 is input to the selector unit 40, since the first output voltage Vs1 is equal to or more than the first threshold Vs_th1, the first comparator 41 outputs the high level H signal to the first NAND circuit 51. In addition, since the first output voltage Vs1 is larger than the second threshold Vs_th2, the second comparator 42 outputs the low level L signal to the first NAND circuit 51. As a result, the first NAND circuit 51 outputs the high level H signal to the S terminal of the SR latch circuit 70.

Additionally, since the first output voltage Vs1 is equal to or more than the third threshold Vs_th3, the third comparator 43 outputs the low level L signal to the second NAND circuit 52. Moreover, since the first output voltage Vs1 is equal to or less than the fourth threshold Vs_th4, the fourth comparator 44 outputs the high level H signal to the second NAND circuit 52. As a result, the second NAND circuit 52 outputs the low level L signal to the AND circuit 60.

Meanwhile, due to the increased rotation angle θ, the second output voltage Vs decreases. At this time, the second output voltage Vs2 becomes larger than the fourth threshold Vs_th4 and less than the second thrsholdVs_th2. When the second output voltage Vs2 is input to the selector unit 40, since the second output voltage Vs2 is equal to or more than the third threshold Vs_th3, the fifth comparator 45 outputs the high level H signal to the third NAND circuit 53. Additionally, since the second output voltage Vs2 is larger than the fourth threshold Vs_th4, the sixth comparator 46 outputs the low level L signal to the third NAND circuit 53. As a result, the third NAND circuit 53 outputs the high level H signal to the AND circuit 60.

Thus, the signals input to the AND circuit 60 are the high level H signal from the second NAND circuit 52 and the high level H signal from the third NAND circuit 53. Accordingly, the AND circuit 60 outputs the high level H signal to the R terminal of the SR latch circuit 70.

Consequently, the signal input to the S terminal of the SR latch is on the high level H, while the signal input to the R terminal of the SR latch circuit 70 is on the high level H. As a result, the SR latch circuit 70 outputs the low level L signal from the Q bar terminal to the switching unit 75 and to the rotation angle computing unit 80.

The switching unit 75, which receives the low level L signal from the SR latch circuit 70, switches the voltage to be output to the rotation angle computing unit 80 to the second output voltage Vs2.

The rotation angle computing unit 80 receives the low level L signal from the SR latch circuit 70. As a result, the rotation angle computing unit 80 determines that the second output voltage Vs2 is applied to the rotation angle computing unit 80. At this time, as described above, the voltage applied from the switching unit 75 to the rotation angle computing unit 80 is the second output voltage Vs2. Therefore, the rotation angle computing unit 80 computes the rotation angle θ on the basis of the second output voltage Vs2. Specifically, the rotation angle computing unit 80 substitutes K2, V2, and the second output voltage Vs2 applied to the rotation angle computing unit 80 in Relational Expression (3-2) shown above to compute the rotation angle θ.

As a result of the rotation of the rotary body 10 from the initial state, the rotation angle θ becomes at least 86 and less than 360°. Due to the increased rotation angle θ, the first output voltage Vs1 increases. At this time, the first output voltage Vs1 becomes larger than the second threshold Vs_th2. When the first output voltage Vs1 is input to the selector unit 40, since the first output voltage Vs1 is equal to or more than the first threshold Vs_th1, the first comparator 41 outputs the high level H signal to the first NAND circuit 51. In addition, since the first output voltage Vs1 is larger than the second threshold Vs_th2, the second comparator 42 outputs the low level L signal to the first NAND circuit 51. As a result, the first NAND circuit 51 outputs the high level H signal to the S terminal of the SR latch circuit 70.

Additionally, since the first output voltage Vs1 is equal to or more than the third threshold Vs_th3, the third comparator 43 outputs the high level H signal to the second NAND circuit 52. Moreover, since the first output voltage Vs1 is larger than the fourth threshold Vs_th4, the fourth comparator 44 outputs the low level L signal to the second NAND circuit 52. As a result, the second NAND circuit 52 outputs the high level H signal to the AND circuit 60.

Meanwhile, due to the increased rotation angle θ, the second output voltage Vs decreases. At this time, the second output voltage Vs2 becomes larger than the third threshold Vs_th3 and at most the fourth threshold Vs_th4. When the second output voltage Vs2 is input to the selector unit 40, since the second output voltage Vs2 is equal to or more than the third threshold Vs_th3, the fifth comparator 45 outputs the high level H signal to the third NAND circuit 53. Additionally, since the second output voltage Vs2 is equal to or less than the fourth threshold Vs_th4, the sixth comparator 46 outputs the high level H signal to the third NAND circuit 53. As a result, the third NAND circuit 53 outputs the low level L signal to the AND circuit 60.

Thus, the signals input to the AND circuit 60 are the high level H signal from the second NAND circuit 52 and the low level L signal from the third NAND circuit 53. Accordingly, the AND circuit 60 outputs the low level L signal to the R terminal of the SR latch circuit 70.

Consequently, the signal input to the S terminal of the SR latch is on the high level H, while the signal input to the R terminal of the SR latch circuit 70 is on the low level L. As a result, the SR latch circuit 70 outputs the low level L signal from the Q bar terminal to the switching unit 75 and to the rotation angle computing unit 80.

The switching unit 75, which receives the low level L signal from the SR latch circuit 70, leaves the voltage to be output to the rotation angle computing unit 80 at the second output voltage Vs2.

The rotation angle computing unit 80 receives the low level L signal from the SR latch circuit 70. As a result, the rotation angle computing unit 80 determines that the second output voltage Vs2 is applied to the rotation angle computing unit 80. At this time, as described above, the voltage applied from the switching unit 75 to the rotation angle computing unit 80 is the second output voltage Vs2. Therefore, the rotation angle computing unit 80 computes the rotation angle θ on the basis of the second output voltage Vs2. Specifically, the rotation angle computing unit 80 substitutes K2, V2, and the second output voltage Vs2 applied to the rotation angle computing unit 80 in Relational Expression (3-2) shown above to compute the rotation angle θ.

Then, the rotary body 10 rotates to return to the initial state. In other words, the rotation angle θ becomes zero. Then, in the same manner as described above, the selector unit 40 selects, as a voltage to be output to the rotation angle computing unit 80, either one of the first output voltage Vs1 and the second output voltage Vs2. Meanwhile, the switching unit 75 switches, on the basis of the signal from the selector unit 40, a voltage to be output to the rotation angle computing unit 80 to either one of the first output voltage Vs1 and the second output voltage Vs2. In addition, the rotation angle computing unit 80 computes the rotation angle θ on the basis of each of the signal from the selector unit 40 and the voltage applied to the rotation angle computing unit 80.

In a case where the rotation angle θ becomes 360 degrees, when switching from the maximum value to zero, the first output voltage Vs1 may have a momentary value which is larger than the fourth threshold Vs_th4 and at most second threshold Vs_th2. When the first output voltage Vs1 is input to the selector unit 40, since the first output voltage Vs1 is equal to or more than the first threshold Vs_th1, the first comparator 41 outputs the high level H signal to the first NAND circuit 51. In addition, since the first output voltage Vs1 is equal to or less than the second threshold Vs_th2, the second comparator 42 outputs the high level H signal to the first NAND circuit 51. As a result, the first NAND circuit 51 outputs the low level L signal to the S terminal of the SR latch circuit 70.

Additionally, since the first output voltage Vs1 is equal to or more than the third threshold Vs_th3, the third comparator 43 outputs the low level L signal to the second NAND circuit 52. Moreover, since the first output voltage Vs1 is larger than the fourth threshold Vs_th4, the fourth comparator 44 outputs the low level L signal to the second NAND circuit 52. As a result, the second NAND circuit 52 outputs the high level H signal to the AND circuit 60.

When the rotation angle θ is in the vicinity of 360 degrees, the second output voltage Vs2 is larger than the third threshold Vs_th3 and less than the fourth threshold Vs_th4. Consequently, in the same manner as described above, the signal from the third NAND circuit 53 is on the low level L.

Thus, the signals input to the AND circuit 60 are the high level H signal from the second NAND circuit 52 and the low level L signal from the third NAND circuit 53. Accordingly, the AND circuit 60 outputs the low level L signal to the R terminal of the SR latch circuit 70.

Consequently, the signal input to the S terminal of the SR latch is on the low level L, while the signal input to the R terminal of the SR latch circuit 70 is on the low level L. As a result, the SR latch circuit 70 holds the previous state. Since the previous signal in the SR latch circuit 70 is on the low level L, the SR latch circuit 70 outputs the low level L signal from the Q bar terminal to the switching unit 75 and to the rotation angle computing unit 80.

The switching unit 75, which receives the low level L signal from the SR latch circuit 70, leaves the voltage to be output to the rotation angle computing unit 80 at the second output voltage Vs2.

The rotation angle computing unit 80 receives the low level L signal from the SR latch circuit 70. As a result, the rotation angle computing unit 80 determines that the second output voltage Vs2 is applied to the rotation angle computing unit 80. Therefore, the rotation angle computing unit 80 computes the rotation angle θ on the basis of the second output voltage Vs2. Specifically, the rotation angle computing unit 80 substitutes K2, V2, and the second output voltage Vs2 applied to the rotation angle computing unit 80 in Relational Expression (3-2) shown above to compute the rotation angle θ.

In a case where the rotation angle θ becomes 360 degrees, when switching from the maximum value to zero, the first output voltage Vs1 may have a momentary value which is at least the third threshold Vs_th3 and at most the fourth threshold Vs_th4. When the first output voltage Vs1 is input to the selector unit 40, since the first output voltage Vs1 is equal to or more than the first threshold Vs_th1, the first comparator 41 outputs the high level H signal to the first NAND circuit 51. In addition, since the first output voltage Vs1 is equal to or less than the second threshold Vs_th2, the second comparator 42 outputs the high level H signal to the first NAND circuit 51. As a result, the first NAND circuit 51 outputs the low level L signal to the S terminal of the SR latch circuit 70.

Additionally, since the first output voltage Vs1 is equal to or more than the third threshold Vs_th3, the third comparator 43 outputs the low level L signal to the second NAND circuit 52. Moreover, since the first output voltage Vs1 is equal to or less than the fourth threshold Vs_th4, the fourth comparator 44 outputs the high level H signal to the second NAND circuit 52. As a result, the second NAND circuit 52 outputs the low level L signal to the AND circuit 60.

When the rotation angle θ is in the vicinity of 360 degrees, the second output voltage Vs2 is larger than the third threshold Vs_th3 and less than the fourth threshold Vs_th4. Consequently, in the same manner as described above, the signal from the third NAND circuit 53 is on the low level L.

Thus, the signals input to the AND circuit 60 are the low level L signal from the second NAND circuit 52 and the low level L signal from the third NAND circuit 53. Accordingly, the AND circuit 60 outputs the low level L signal to the R terminal of the SR latch circuit 70.

Consequently, the signal input to the S terminal of the SR latch is on the low level L, while the signal input to the R terminal of the SR latch circuit 70 is on the low level L. As a result, the SR latch circuit 70 holds the previous state. Since the previous signal in the SR latch circuit 70 is on the low level L, the SR latch circuit 70 outputs the low level L signal from the Q bar terminal to the switching unit 75 and to the rotation angle computing unit 80.

The switching unit 75, which receives the low level L signal from the SR latch circuit 70, leaves the voltage to be output to the rotation angle computing unit 80 at the second output voltage Vs2.

The rotation angle computing unit 80 receives the low level L signal from the SR latch circuit 70. As a result, the rotation angle computing unit 80 determines that the second output voltage Vs2 is applied to the rotation angle computing unit 80. Therefore, the rotation angle computing unit 80 computes the rotation angle θ on the basis of the second output voltage Vs2. Specifically, the rotation angle computing unit 80 substitutes K2, V2, and the second output voltage Vs2 applied to the rotation angle computing unit 80 in Relational Expression (3-2) shown above to compute the rotation angle θ.

In a case where the rotation angle θ becomes 360 degrees, when switching from the maximum value to zero, the first output voltage Vs1 may have a momentary value which is at least the first threshold Vs_th1 and less than the third threshold Vs_th3. When the first output voltage Vs1 is input to the selector unit 40, since the first output voltage Vs1 is equal to or more than the first threshold Vs_th1, the first comparator 41 outputs the high level H signal to the first NAND circuit 51. In addition, since the first output voltage Vs1 is equal to or less than the second threshold Vs_th2, the second comparator 42 outputs the high level H signal to the first NAND circuit 51. As a result, the first NAND circuit 51 outputs the low level L signal to the S terminal of the SR latch circuit 70.

Moreover, since the first output voltage Vs1 is less than the third threshold Vs_th3, the third comparator 43 outputs the low level L signal to the second NAND circuit 52. Furthermore, since the first output voltage Vs1 is equal to or less than the fourth threshold Vs_th4, the fourth comparator 44 outputs the high level H signal to the second NAND circuit 52. As a result, the second NAND circuit 52 outputs the high level H signal to the AND circuit 60.

When the rotation angle θ is in the vicinity of 360 degrees, the second output voltage Vs2 is larger than the third threshold Vs_th3 and less than the fourth threshold Vs_th4. Consequently, in the same manner as described above, the signal from the third NAND circuit 53 is on the low level L.

Thus, the signals input to the AND circuit 60 are the high level H signal from the second NAND circuit 52 and the low level L signal from the third NAND circuit 53. Accordingly, the AND circuit 60 outputs the low level L signal to the R terminal of the SR latch circuit 70.

Consequently, the signal input to the S terminal of the SR latch is on the low level L, while the signal input to the R terminal of the SR latch circuit 70 is on the low level L. As a result, the SR latch circuit 70 holds the previous state. Since the previous signal in the SR latch circuit 70 is on the low level L, the SR latch circuit 70 outputs the low level L signal from the Q bar terminal to the switching unit 75 and to the rotation angle computing unit 80.

The switching unit 75, which receives the low level L signal from the SR latch circuit 70, leaves the voltage to be output to the rotation angle computing unit 80 at the second output voltage Vs2.

The rotation angle computing unit 80 receives the low level L signal from the SR latch circuit 70. As a result, the rotation angle computing unit 80 determines that the second output voltage Vs2 is applied to the rotation angle computing unit 80. Therefore, the rotation angle computing unit 80 computes the rotation angle θ on the basis of the second output voltage Vs2. Specifically, the rotation angle computing unit 80 substitutes K2, V2, and the second output voltage Vs2 applied to the rotation angle computing unit 80 in Relational Expression (3-2) shown above to compute the rotation angle θ.

Thus, in the rotation angle detecting device 1, the rotation angle θ is detected. The rotation angle detecting device 1 can continuously detect the rotation angle θ. A description will be given below of continuous detection of the rotation angle θ.

In the rotation angle detecting device 1, the rotation angle detecting unit 30 outputs the first output voltage Vs1 that increases as the rotation angle θ of the rotary body 10 increases in the first cycle having, as one cycle period, a predetermined range of the rotation angle θ, which is a range in which the rotation angle θ is at least zero and less than 360 herein. The rotation angle detecting unit 30 also outputs the second output voltage Vs2 that decreases as the rotation angle θ of the rotary body 10 increases in a second cycle having, as one cycle period, a range of the rotation angle θ different from that of the first cycle, which is a range in which the rotation angle θ is larger than 180 degrees and at most 540 degrees herein. Accordingly, the second output voltage Vs2 varies with the rotation angle θ, and the variation in the second output voltage Vs2 has a positive/negative sign different from that of a variation in the first output voltage Vs1.

As also illustrated in FIG. 9, at the plurality of rotation angles 8 during one cycle period of the first cycle, the magnitude relationship between the first output voltage Vs1 and the second output voltage Vs2 changes with variation in the rotation angle θ. At this time, the first threshold Vs_th1 corresponds to a minimum value of the first output voltage Vs1 corresponding to the plurality of rotation angles 8. The first threshold Vs_th1 also corresponds to a minimum value of the second output voltage Vs2 corresponding to the plurality rotation angles 8. Meanwhile, the second threshold Vs_th2 corresponds to a maximum value of the first output voltage Vs1 corresponding to the plurality of rotation angles 8. The second threshold Vs_th2 also corresponds to a maximum value of the second output voltages Vs2 corresponding to the plurality of rotation angles 8. As also illustrated in FIG. 9, a line obtained by plotting the first output voltage Vs1 corresponding to the rotation angles during one cycle period and a line obtained by plotting the second output voltage Vs2 corresponding to the rotation angles 8 during two consecutive cycle periods cross each other, and two points of intersection are generated. The first threshold Vs_th1 corresponds to a minimum value of the voltage corresponding to one of the points of intersection, while the second threshold Vs_th2 corresponds to a maximum value of the voltage corresponding to one of the points of intersection.

Consequently, in a range of at least the first threshold Vs_th1 and at most the second threshold Vs_th2, the voltage output from the rotation angle detecting unit 30 has a value which is continuous at any rotation angle θ and has a one-by-one relationship with the rotation angle θ.

The selector unit 40 selects the one of the first voltage Vs1 and the second output voltage that is at least the first threshold Vs_th1 and at most the second threshold Vs_th2. As a result, the voltage selected by the selector unit 40 has a value which is continuous at any rotation angle θ and has a one-by-one relationship with the rotation angle θ.

The rotation angle computing unit 80 computes the rotation angle θ on the basis of the voltage selected by the selector unit 40. Thus, the rotation angle θ is computed on the basis of the value which is continuous at any rotation angle θ and has the one-by-one relationship with the rotation angle θ, and therefore the rotation angle detecting device 1 can continuously detect the rotation angle θ.

Additionally, the rotation angle detecting device 1 also achieves effects as described below.

When the first output voltage Vs1 switches from the maximum value to zero or when the second output voltage Vs2 switches from zero to the maximum value, the first output voltage Vs1 and the second output voltage Vs2 exhibit variations having the same positive/negative sign. In this case, the first output voltage Vs1 and the second output voltage Vs2 when the magnitude relationship between the first output voltage Vs1 and the second output voltage Vs2 changes are at least the third threshold Vs_th3 and at most the fourth threshold Vs_th4.

In a case where the rotation angle θ exceeds 180 degrees, a line obtained by plotting the second output voltage Vs2 with respect to the rotation angle θ when the second output voltage Vs2 switches from zero to the maximum value crosses a line obtained by plotting the first output voltage Vs1 with respect to the rotation angle θ. A voltage corresponding to the resulting point of intersection is set to be at least the third threshold Vs_th3 and at most the fourth threshold Vs_th4.

In a case where the rotation angle θ exceeds 180 degrees as illustrated in, e.g., FIG. 9, when switching from zero to the maximum value, the second output voltage Vs2 may have a momentary value which is at least the first threshold Vs_th1 and at most the second threshold Vs_th2. At this time also, the selector unit 40 holds the selection made thereby in the range of at least the third threshold Vs_th3 and at most the fourth threshold Vs_th4 which is set as described above and thereby appropriately selects the first output voltage Vs1. Thus, the selector unit 40 is inhibited from making an erroneous determination.

In a case where the rotation angle θ is 360 degrees, a line obtained by plotting the first output voltage Vs1 with respect to the rotation angle θ when the first output voltage Vs1 switches from the maximum value to zero crosses a line obtained by plotting the second output voltage Vs2 with respect to the rotation angle θ. A voltage corresponding to the resulting point of intersection is set to be at least the third threshold Vs_th3 and at most the fourth threshold Vs_th4.

In a case where the rotation angle θ is, e.g., 360 degrees, when switching from the maximum value to zero, the first output voltage Vs1 may have a momentary value which is larger than the fourth threshold Vs_th4 and at most the second threshold Vs_th2. At this time also, the selector unit 40 holds the selection made thereby in the range of at least the threshold Vs_th3 and at most the fourth threshold Vs_th4 which is set as described above and thereby appropriately selects the second output voltage Vs2. Thus, the selector unit 40 is inhibited from making an erroneous determination.

### Second Embodiment

In the second embodiment, a form of the selector unit 40 is different from that in the first embodiment. The second embodiment is otherwise the same as the first embodiment.

The selector unit 40 is configured herein to include a digital circuit as a main component, and has a CPU, a ROM, a RAM, a flash memory, an I/O, a bus line connecting these components, and the like. The selector unit 40 executes a program stored in the ROM to select, as a voltage to be applied to the rotation angle computing unit 80, either one of the first output voltage Vs1 and the second output voltage Vs2. The selector unit 40 further outputs a signal representing the selected voltage to the rotation angle computing unit 80. The selector unit 40 also causes the switching unit 75 to apply the selected voltage to the rotation angle computing unit 80. Each of the ROM, the RAM, and the flash memory is a non-transitory tangible storage medium.

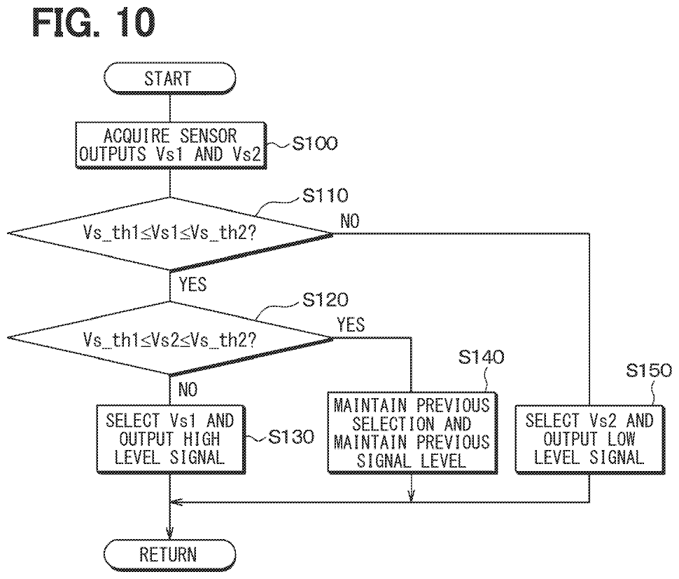

For example, when a voltage is supplied from a power source not shown to the selector unit 40, the selector unit 40 executes the program stored in the ROM. Processing by the selector unit 40 will be described with reference to a flow chart in FIG. 10.

In Step S100, the selector unit 40 acquires the first output voltage Vs1 from the first output computing circuit 311. The selector unit 40 also acquires the second output voltage Vs2 from the second output computing circuit 312.

Subsequently, in Step S110, the selector unit 40 determines whether or not the first output voltage Vs1 acquired in Step S100 is at least the first threshold Vs_th1 and at most the second threshold Vs_th2. When the first output voltage Vs1 is at last the first threshold Vs_th1 and at most the second threshold Vs_th2, the processing moves to Step S120. When the first output voltage Vs1 is less than the first threshold Vs_th1, the processing moves to Step S150. When the first output voltage Vs1 is larger than the second threshold Vs_th2, the processing moves to Step S150.

In Step S120 subsequent to Step S110, the selector unit 40 determines whether or not the second output voltage Vs2 is at least the first threshold Vs_th1 and at most the second threshold Vs_th2. When the second output voltage Vs2 is at least the first threshold Vs_th1 and at most the second threshold Vs_th2, the processing moves to Step S140. When the second output voltage Vs2 is less than the first threshold Vs_th1, the processing moves to Step S130. When the second output voltage Vs2 is larger than the second threshold Vs_th2, the processing moves to Step S130.

In Step S130 subsequent to Step S120, the selector unit 40 selects the first output voltage Vs1 as the voltage to be applied to the rotation angle computing unit 80. Specifically, the selector unit 40 outputs a high level H signal to each of the switching unit 75 and the rotation angle computing unit 80.

The switching unit 75 receives the high level H signal, and accordingly switches the voltage to be output to the rotation angle computing unit 80 to the first output voltage Vs1.

The rotation angle computing unit 80 receives the high level H signal from the selector unit 40. Accordingly, the rotation angle computing unit 80 determines that the first output voltage Vs1 is applied to the rotation angle computing unit 80. At this time, as described above, the voltage to be applied by the switching unit 75 to the rotation angle computing unit 80 is the first output voltage Vs1. Accordingly, the rotation angle computing unit 80 computes the rotation angle θ on the basis of the first output voltage Vs1. Specifically, the rotation angle computing unit 80 substitutes K1, V1, and the first output voltage Vs1 applied to the rotation angle computing unit 80 in Relational Expression (3-1) shown above to compute the rotation angle θ. Then, the processing returns to Step S100.

In Step S140 subsequent to Step S120, the selector unit 40 maintains the previously selected voltage. Specifically, the selector unit 40 maintains the previous signal level and thereby outputs the previous signal level to the switching unit 75 and to the rotation angle computing unit 80.

For example, when the previous signal level from the selector unit 40 is on the high level H, the switching unit 75 receives the high level H signal, and accordingly leaves the voltage to be output to the rotation angle computing unit 80 at the first output voltage Vs1.

The rotation angle computing unit 80 receives the high level H signal from the selector unit 40. Therefore, the rotation angle computing unit 80 determines that the first output voltage Vs1 is applied to the rotation angle computing unit 80. At this time, as described above, the voltage to be applied by the switching unit 75 to the rotation angle computing unit 80 is the first output voltage Vs1. Accordingly, the rotation angle computing unit 80 computes the rotation angle θ on the basis of the first output voltage Vs1. Specifically, the rotation angle computing unit 80 substitutes K1, V1, and the first output voltage Vs1 applied to the rotation angle computing unit 80 in Relational Expression (3-1) shown above to compute the rotation angle θ. Then, the processing returns to Step S100.

When the previous signal level from the selector unit 40 is the low level L, the switching unit 75 receives a low level L signal from the selector unit 40, and accordingly leaves the voltage to be applied to the rotation angle computing unit 80 at the second output voltage Vs2.

The rotation angle computing unit 80 receives the low level L signal from the selector unit 40. Therefore, the rotation angle computing unit 80 determines that the second output voltage Vs2 is applied to the rotation angle computing unit 80. At this time, as described above, the voltage to be applied by the switching unit 75 to the rotation angle computing unit 80 is the second output voltage Vs2. Accordingly, the rotation angle computing unit 80 computes the rotation angle θ on the basis of the second output voltage Vs2. Specifically, the rotation angle computing unit 80 substitutes K2, V2, and the second output voltage Vs2 applied to the rotation angle computing unit 80 in Relational Expression (3-2) shown above to compute the rotation angle θ. Then, the processing returns to Step S100.

Note that, in the same manner as described above, when the rotation angle θ exceeds 180 degrees and the second output voltage Vs2 switches from zero to the maximum value, the second output voltage Vs2 may have a momentary value which is at least the first threshold Vs_th1 and at most the second threshold Vs_th2. The selector unit 40 maintains the previous selection as the voltage to be applied to the rotation angle computing unit 80. Specifically, when the rotation angle θ is 180 degrees, the first output voltage Vs1 is at least the first threshold Vs_th1 and at most the second threshold Vs_th2 and the second output voltage Vs2 is zero, which is less than the first threshold Vs_th1. Therefore, when the rotation angle θ is 180 degrees, the selector unit 40 selects the first output voltage Vs1. Accordingly, when the rotation angle θ exceeds 180 degrees and the second output voltage Vs2 has a momentary value which is at least the first threshold Vs_th1 and at most the second threshold Vs_th2, the selector unit 40 maintains the previous selection, which is the selection of the first output voltage Vs1. As a result, even though the second output voltage Vs2 becomes at least the first threshold Vs_th1 and at most the second threshold Vs_th2 when switching from zero to the maximum value, the selector unit 40 is inhibited from making an erroneous determination.

Meanwhile, when the rotation angle θ becomes 360 degrees and the first output voltage Vs1 switches from the maximum value to zero, the first output voltage Vs1 may have a momentary value which is at least the first threshold Vs_th1 and at most the second threshold Vs_th2. In the same manner as described above, the selector unit 40 maintains the previous selection as the voltage to be applied to the rotation angle computing unit 80. Specifically, immediately before the rotation angle θ becomes 360 degrees, the second output voltage Vs2 is at least the first threshold Vs_th1 and at most the second threshold Vs_th2 and the first output voltage Vs1 has a maximum value, which is larger than the second threshold Vs_th2. Accordingly, immediately before the rotation angle θ becomes 360 degrees, the selector unit 40 selects the second output voltage Vs2. Therefore, when the rotation angle θ becomes 360 degrees and the first output voltage Vs1 has a momentary value which is at least the first threshold Vs_th1 and at most the second threshold Vs_th2, the selector unit 40 maintains the previous selection, which is the selection of the second output voltage Vs2. As a result, even though the first output voltage Vs1 becomes at least the first threshold Vs_th1 and at most the second threshold Vs_th2 when switching from the maximum value to zero, the selector unit 40 is inhibited from making an erroneous determination.

In Step S150 subsequent to Step S110, the second output voltage Vs2 is at least the first threshold Vs_th1 and at most the second threshold Vs_th2. Therefore, the selector unit 40 selects the second output voltage Vs2 as the voltage to be applied to the rotation angle computing unit 80. Specifically, the selector unit 40 outputs the low level L signal to the switching unit 75 and to the rotation angle computing unit 80.

The switching unit 75 receives the low level L signal from the selector unit 40, and accordingly switches the voltage output to the rotation angle computing unit 80 to the second output voltage Vs2.

The rotation angle computing unit 80 receives the low level L signal from the selector unit 40. Therefore, the rotation angle computing unit 80 determines that the second output voltage Vs2 is applied to the rotation angle computing unit 80. At this time, as described above, the voltage applied by the switching unit 75 to the rotation angle computing unit 80 is the second output voltage Vs2. Accordingly, the rotation angle computing unit 80 computes the rotation angle θ on the basis of the second output voltage Vs2. Specifically, the rotation angle computing unit 80 substitutes K2, V2, and the second output voltage Vs2 applied to the rotation angle computing unit 80 in Relational Expression (3-2) shown above to compute the rotation angle θ. Then, the processing returns to Step S100.

Thus, the processing is performed by the selector unit 40. In the second embodiment also, the same effects as achieved in the first embodiment are achieved.

### Third Embodiment

In the third embodiment, the computation of the first output voltage Vs by the first output computing circuit 311 and the computation of the second output voltage Vs2 by the second output computing circuit 312 is different from that in the first embodiment. The third embodiment is otherwise the same as the first embodiment.

As shown below in Relational Expression (4-1), the first output computing circuit 311 computes the first output voltage Vs1 on the basis of the first X-direction magnetic flux ϕx1, the first Y-direction magnetic flux ϕy1, and the rotation angle θ. In Relational Expression (4-1), K3 is a factor related to the rotation angle θ. In addition, K3 is set to a positive value. Moreover, an absolute value of K3 is larger than an absolute value of K1 mentioned above. Additionally, V3 is a constant. V3 is set such that, when the rotation angle θ is θt1, the first output voltage Vs1 is zero. Each of 8t1 and 8t2 is any constant related to the rotation angle θ. For example, θt1 is set to 60 degrees, θt2 is set to 300 degrees, and n is an integer equal to or more than zero.

Vs1=K3×arctan(ϕy1/ϕx1)+V3

=K3×θ+V3

(when θt1+360×n≤θ<θt2+360×n is satisfied)

Vs1=0

(when either 360×n≤θθt1+360×n or θt2+360×n≤θ<360×(n+1) is satisfied) (4-1)

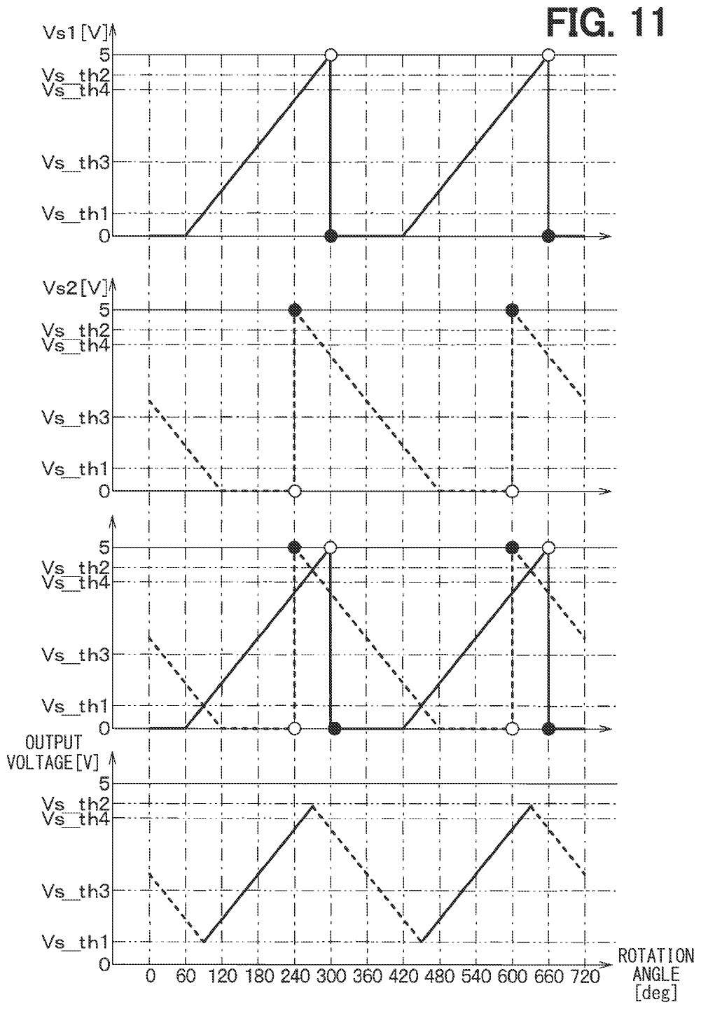

Accordingly, as illustrated in FIG. 11, the first output voltage Vs1 is zero herein when the rotation angle θ is at least zero degrees and less than 60 degrees. When the rotation angle θ is at least 60 degrees and less than 300 degrees, the first output voltage Vs1 increases as the rotation angle θ increases. The first output voltage Vs1 reaches a maximum value immediately before the rotation angle θ becomes 300 degrees. The first output voltage Vs1 returns to zero when the rotation angle θ becomes 300 degrees. The first output voltage Vs1 is zero when the rotation angle θ is more than 300 degrees and less than 360 degrees.

Thus, the first output computing circuit 311 computes the first output voltage Vs1.

Likewise, as shown below in Relational Expression (4-2), the second output computing circuit 312 computes the second output voltage Vs2 on the basis of the second X-direction magnetic flux ϕx2, the second Y-direction magnetic flux ϕy2, and the rotation angle θ. In Relational Expression (4-2), K4 is a factor related to the rotation angle θ. In addition, K4 is set to have a positive/negative sign different from that of K3. Accordingly, K4 is set to a negative value. Moreover, an absolute value of K4 is set larger than an absolute value of K2 to be the same as the absolute value of K3. Additionally, V4 is a constant. V4 is set such that, when the rotation angle θ is θt3, the second output voltage Vs2 is zero. Each of θt3 and θt4 is any constant related to the rotation angle θ. For example, θt3 is set to 120 degrees, while θt4 is set to 240 degrees.

Vs2=K4×arctan(ϕy2/ϕx2)+V4

=K4×θ+V4

(when either 360×n≤θ<θt3+360×n or θt4+360×n≤θ<360×(n+1) is satisfied)

Vs2=0

(when θt3+360×n≤<θt4+360×n is satisfied) (4-2)

Accordingly, when the rotation angle θ is at least zero and less than 120 degrees, the second output voltage Vs2 decreases herein as the rotation angle θ increases. When the rotation angle θ is at least 120 degrees and less than 240 degrees, the second output voltage Vs2 is zero. The second output voltage reaches a maximum value when the rotation angle θ is 240 degrees. When the rotation angle θ is larger than 240 degrees and less than 360 degrees, the second output voltage Vs2 decreases as the rotation angle θ increases.

Meanwhile, the first threshold Vs_th1 is adjusted to have a minimum value of a voltage corresponding to a point of intersection of a line obtained by plotting the first output voltage Vs1 with respect to the rotation angle θ and a line obtained by plotting the second output voltage Vs2 with respect to the rotation angle θ. Likewise, the second threshold Vs_th2 is adjusted to have a maximum value of the voltage corresponding to the point of intersection of the line obtained by plotting the first output voltage Vs1 with respect to the rotation angle θ and the line obtained by plotting the second output voltage Vs2 with respect to the rotation angle θ.

Thus, the second output computing circuit 312 computes the second output voltage Vs2.

As described above, in the third embodiment, the first output voltage Vs1 and the second output voltage Vs2 are computed. In the third embodiment also, the same effects as achieved in the first embodiment are achieved.

### Fourth Embodiment

In the fourth embodiment, the computation of the second output voltage Vs2 by the second output computing circuit 312 is different from that in the first embodiment. The fourth embodiment is otherwise the same as the first embodiment.

As illustrated below in Relational Expression (5), the second output computing circuit 312 computes the second output voltage Vs2 on the basis of the second X-direction magnetic flux ϕx2, the second Y-direction magnetic flux ϕy2, and the rotation angle θ. In Relational Expression (5), K5 is a factor related to the rotation angle θ. In addition, K5 is set to have a positive/negative sign different from that of K1. Accordingly, K5 is set to a negative value. Moreover, an absolute value of K5 is set to be different from the absolute value of K1. For example, the absolute value of K5 is larger than the absolute value of K1. Additionally, V5 is a constant. V5 is set such that, when the rotation angle θ is θt5, the second output voltage Vs2 is zero. Each of θt5 and θt6 is any constant related to the rotation angle θ. For example, θt5 is set to 120 degrees, while θt6 is set to 330 degrees.

Vs2=K5×arctan(ϕy2/ϕx2)+V5

=K5×θ+V5

(when either 360×n≤θ<θt5+360×n or θt6+360×n≤θ<360×(n+1) is satisfied)

Vs2=0

(when θt5+360×n≤θ<θt6+360×n is satisfied) (5)

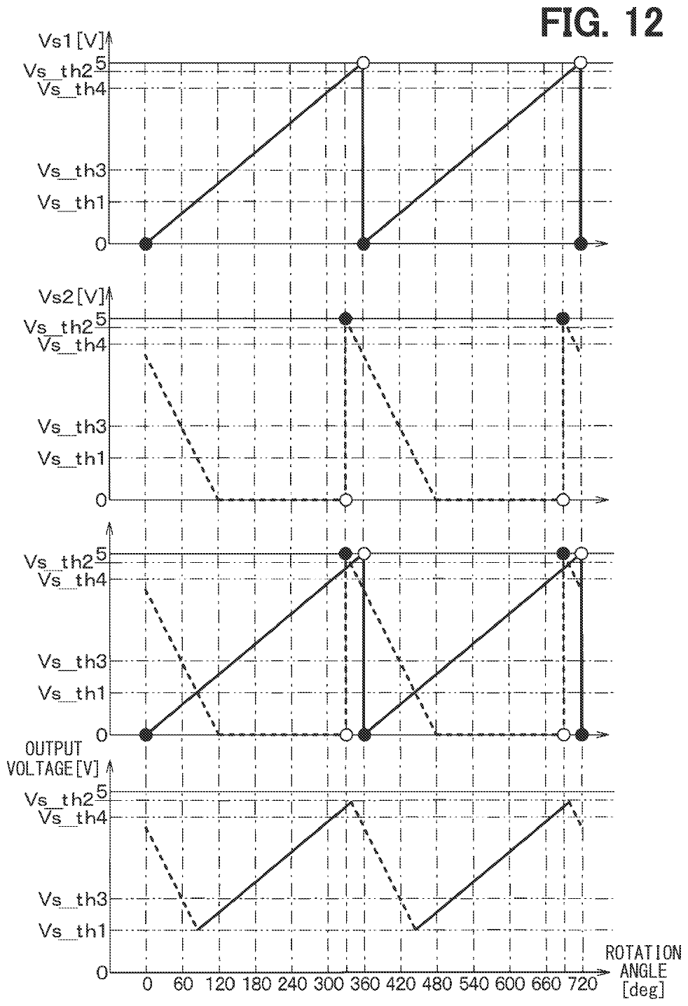

Accordingly, as illustrated in FIG. 12, when the rotation angle θ is at least zero and less than 120 degrees, the second output voltage Vs2 decreases herein as the rotation angle θ increases. When the rotation angle θ is at least 120 degrees and less than 330 degrees, the second output voltage Vs2 is zero. The second output voltage reaches a maximum value when the rotation angle θ is 330 degrees. When the rotation angle θ is larger than 330 degrees and less than 360 degrees, the second output voltage Vs2 decreases as the rotation angle θ increases.

Thus, the second output computing circuit 312 computes the second output voltage Vs2.

Even when an absolute value of a variation in the first output voltage Vs1 with respect to the rotation angle θ is different from an absolute value of a variation in the second output voltage Vs2 with respect to the rotation angle θ as in the fourth embodiment, the same effects as achieved in the first embodiment are achieved.

### Fifth Embodiment

In the fifth embodiment, respective forms of the rotation angle detecting unit 30, the selector unit 40, and the switching unit 75 are different. The fifth embodiment is otherwise the same as the first embodiment.

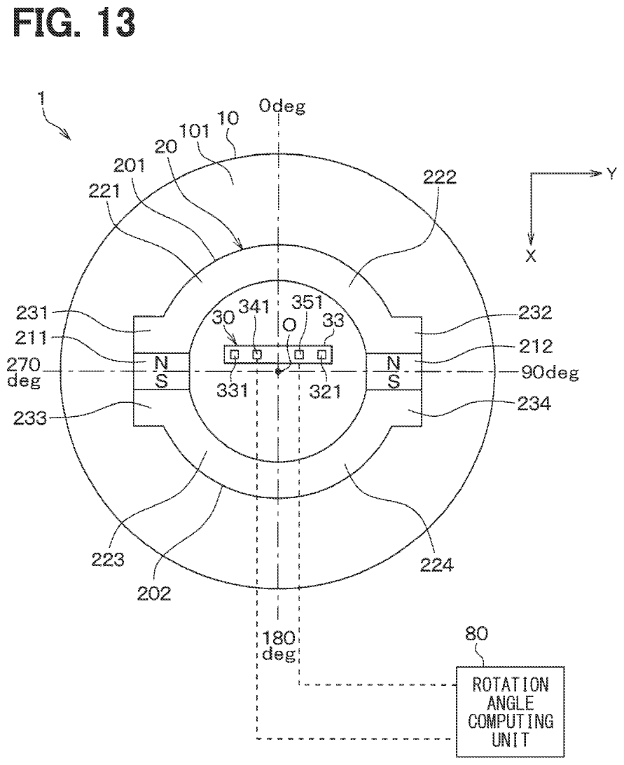

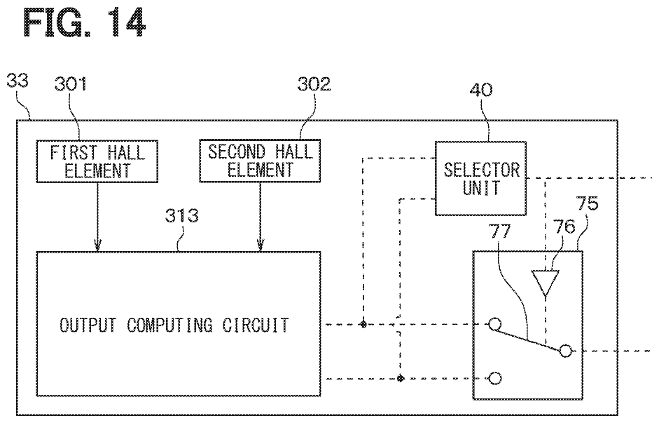

As illustrated in FIG. 13, the rotation angle detecting unit 30 has only one sensor 33. As illustrated in FIGS. 13 and 14, the sensor 33 includes, in addition to the first Hall element 301, the second Hall element 302, the first power source terminal 321, and the first ground terminal 331 each described above, the first output terminal 341, a selector terminal 351, and an output computing circuit 313.

The first output terminal 341 is connected to the switching unit 75 described later. The first output terminal 341 also outputs the voltage from the switching unit 75 to the rotation angle computing unit 80.

The selector terminal 351 is connected to the selector unit 40 described later. The first output terminal 341 also outputs a signal representing the voltage selected by the selector unit 40 to the rotation angle computing unit 80.

In the same manner as in the first embodiment, the output computing circuit 313 uses Relational Expression (3-1) shown above to compute the first output voltage Vs1 on the basis of the first X-direction magnetic flux ϕx1 and the first Y-direction magnetic flux ϕy1. Also, in the same manner as in the first embodiment, the output computing circuit 313 uses Relational Expression (3-2) shown above to compute the second output voltage Vs2 on the basis of the first X-direction magnetic flux ϕx1 and the first Y-direction magnetic flux ϕy1. Then, the output computing circuit 313 outputs the computed first output voltage Vs1 and second output voltage Vs2 to the selector unit 40 and to the switching unit 75.

In the same manner as in the first embodiment, the selector unit 40 selects either one of the first output voltage Vs1 and the second output voltage Vs2 as the voltage to be applied to the rotation angle computing unit 80. The selector unit 40 also outputs a signal representing the selected voltage to the rotation angle computing unit 80. The selector unit 40 further causes the switching unit 75 to apply the selected voltage to the rotation angle computing unit 80. The selector 40 is integrated herein with the rotation angle detecting unit 30.

In the same manner as described above, the switching unit 75 switches the voltage output to the rotation angle computing unit 80 to either one of the first output voltage Vs1 and the second output voltage Vs2 on the basis of a signal from the Q bar terminal of the SR latch circuit 70 of the selector unit 40. The switching unit 75 is integrated herein with the rotation angle detecting unit 30.

Thus, the fifth embodiment is configured. In the fifth embodiment also, the same effects as achieved in the first embodiment are achieved. In addition, in the fifth embodiment, the rotation angle detecting unit 30, the selector unit 40, and the switching unit 75 are integrated with each other, and accordingly the rotation angle detecting device 1 has a relatively simplified configuration.

### Sixth Embodiment

In the sixth embodiment, respective forms of the magnetic field generating unit 20 and the rotation angle detecting unit 30 are different. The sixth embodiment is otherwise the same as the first embodiment.

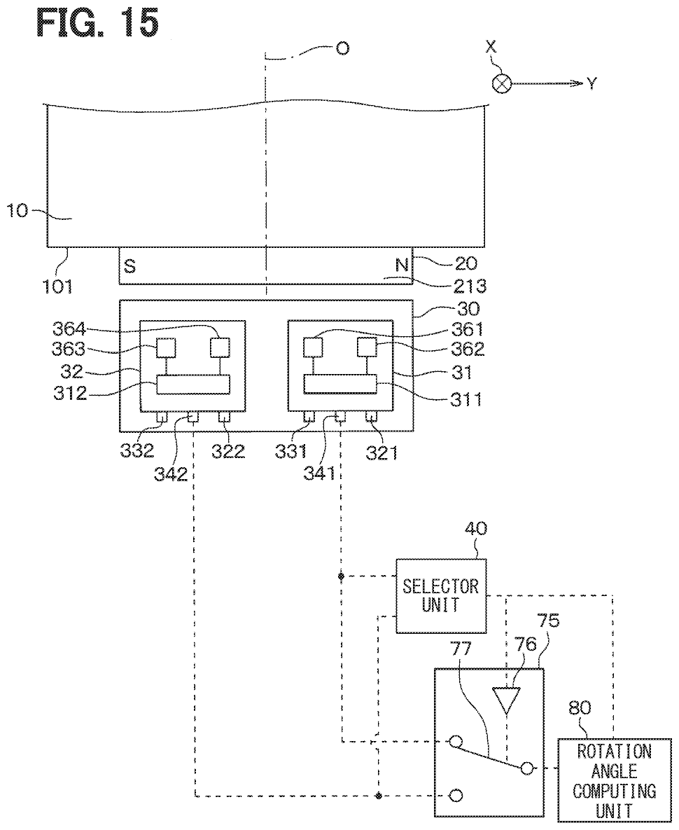

As illustrated in FIG. 15, the magnetic field generating unit 20 has a magnet 213. The magnet 213 is connected to the one end surface 101 of the rotary body 10. Consequently, the magnet 213 rotates together with the rotary body 10. In addition, e.g., one side of the magnet 213 in the Y-direction is magnetized to an N pole. Moreover, another side of the magnet 213 in the Y-direction is magnetized to an S pole. As a result, a magnetic field is generated around the rotary body 10. Note that a direction in which the magnet 213 is magnetized may be reverse to the direction mentioned above.

The rotation angle detecting unit 30 has the first sensor 31 and the second sensor 32.

The first sensor 31 has a first MR element 361 and a second MR element 362 instead of the first Hall element 301 and the second Hall element 302. The first MR element 361 converts a change in the magnetic field resulting from rotation of the magnet 213 to an electric resistance to output a signal according to a magnetic flux flowing in the X-direction to the first output computing circuit 311. The second MR element 362 converts a change in the magnetic field resulting from the rotation of the magnet 213 to an electric resistance to output a signal according to the magnetic flux flowing in the X-direction to the first output computing circuit 311. Note that MR is an abbreviation of Magneto Resistive.

The second sensor 32 has a third MR element 363 and a fourth MR element 364 instead of the third Hall element 303 and the fourth Hall element 304. The third MR element 363 converts a change in the magnetic field resulting from the rotation of the magnet 213 to an electric resistance to output a signal according to the magnetic flux flowing in the X-direction to a third output computing circuit. The fourth MR element 364 converts a change in the magnetic field resulting from the rotation of the magnet 213 to an electric resistance to output a signal according to the magnetic flux flowing in the X-direction to a fourth output computing circuit.

Thus, the sixth embodiment is configured. In the sixth embodiment also, the same effects as achieved in the first embodiment are achieved.

### Seventh Embodiment

In the seventh embodiment, the magnetic field generating unit 20 is not included, and the form of the rotation angle detecting unit 30 is different. The seventh embodiment is otherwise the same as the first embodiment.

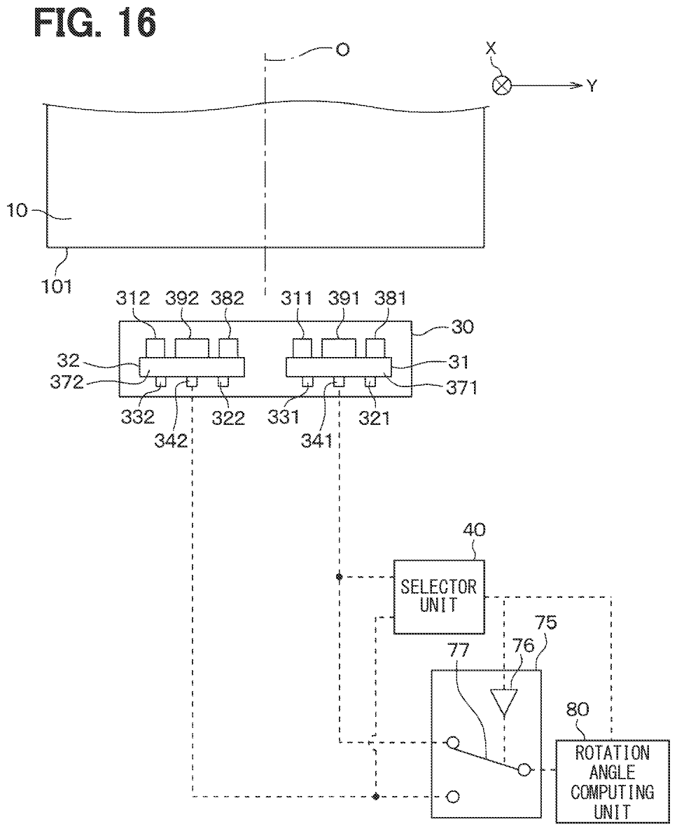

As illustrated in FIG. 16, the rotation angle detecting unit 30 has the first sensor 31 and the second sensor 32.

The first sensor 31 is an inductive sensor and includes a first substrate 371, a first RF transmitting unit 381, a first detecting coil 391, and the first output computing circuit 311. The first substrate 371 is a printed substrate and, on the first substrate 371, the first power source terminal 321, the first ground terminal 331, the first output terminal 341, the first detecting coil 391, the first RF transmitting unit 381, and the first output computing circuit 311 are disposed. The first RF transmitting unit 381 transmits an RF signal of several megahertz to the first detecting coil 391. With the RF signal, the first detecting coil 391 generates an RF magnetic flux. The rotary body 10 is formed herein of metal and, with the RF magnetic flux, an eddy current is generated in the one end surface 101 of the rotary body 10. In addition, the rotation of the rotary body 10 varies a magnitude of the eddy current. As a result, an impedance of the first detecting coil 391 changes. The first output computing circuit 311 outputs, on the basis of the change in the impedance of the first detecting coil 391, the first output voltage Vs1 corresponding to the rotation angle θ of the rotary body 10.

Similarly to the first sensor 31, the second sensor 32 is an inductive sensor and includes a second substrate 372, a second RF transmitting unit 382, a second detecting coil 392, and the second output computing circuit 312. Accordingly, in the same manner as described above, the second output computing circuit 312 outputs, on the basis of a change in an impedance of the second detecting coil 392, the second output voltage Vs2 corresponding to the rotation angle θ of the rotary body 10.

Thus, the seventh embodiment is configured. In the seventh embodiment also, the same effects as achieved in the first embodiment are achieved.

### Eighth Embodiment

In the eighth embodiment, the magnetic field generating unit 20 is not included, and the form of the rotation angle detecting unit 30 is different. The eighth embodiment is otherwise the same as the first embodiment.

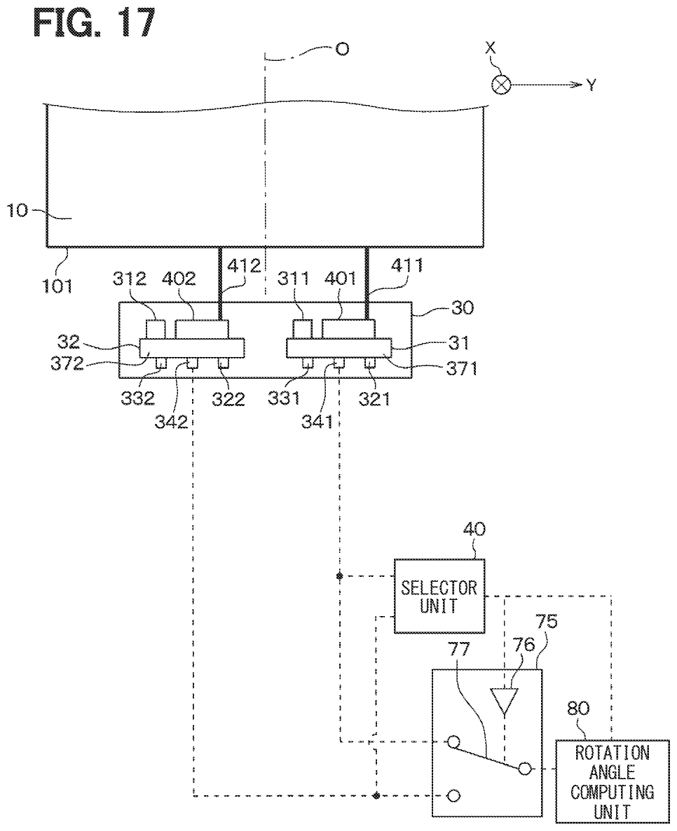

As illustrated in FIG. 17, the rotation angle detecting unit 30 has the first sensor 31 and the second sensor 32.

The first sensor 31 is a potentiometer and includes the first substrate 371, a first resistor body 401, a first contact portion 411, and the first output computing circuit 311. The first substrate 371 is a printed substrate and, on the first substrate 371, the first resistor body 401 is disposed. The first resistor body 401 is formed of, e.g., carbon to extend along a direction of the rotation of the rotary body 10. The first contact portion 411 is connected to the one end surface 101 of the rotary body 10. Accordingly, the first contact portion 411 rotates with the rotary body 10. With the rotation of the first contact portion 411 with the rotary body 10, a position of contact between the first contact portion 411 and the first resistor body 401 varies. As a result, a measurement resistance of the first resistor body 401 varies. The first output computing circuit 311 outputs, on the basis of the variation in the measurement resistance of the first resistor body 401, the first output voltage Vs1 corresponding to the rotation angle θ of the rotary body 10.

Similarly to the first sensor 31, the second sensor 32 is a potentiometer and includes the second substrate 372, a second resistor body 402, a second contact portion 412, and the second output computing circuit 312. In the same manner as in the first sensor 31, the second output computing circuit 312 outputs, on the basis of a variation in a measurement resistance of the second resistor body 402, the second output voltage Vs2 corresponding to the rotation angle θ of the rotary body 10.

Thus, the eighth embodiment is configured. In the eighth embodiment also, the same effects as achieved in the first embodiment are achieved.

### Other Embodiments

The present disclosure is not limited to the embodiments described above and can appropriately be changed from the embodiments described above. Needless to say, in each of the embodiments described above, the components thereof are not necessarily indispensable unless particularly explicitly described otherwise or unless the components are considered to be obviously indispensable in principle.

The computing units and the like and the methods therefor each described in the present disclosure may also be implemented by a dedicated computer provided by configuring a processor programmed to perform one or a plurality of functions embodied by a computer program and a memory. Alternatively, the computing units and the like and the methods therefor each described in the present disclosure may also be implemented by a dedicated computer provided by forming a processor of one or more dedicated hardware logic circuits. Still alternatively, the computing units and the like and the methods therefor each described in the present disclosure may also be implemented by one or more dedicated computers including a combination of a processor programmed to perform one or a plurality of functions and a memory, and a processor including one or more hardware logic circuits. The computer program may also be stored as an instruction to be executed by the computer in a computer readable non-transitory tangible recording medium.

In the embodiments described above, V2 is set such that the second output voltage Vs2 is zero when the rotation angle θ is, e.g., 180 degrees. The setting of V2 is not limited thereto, and V2 may also be set such that the second output voltage Vs2 is 5 V as a maximum value when the rotation angle θ is, e.g., 180 degrees.

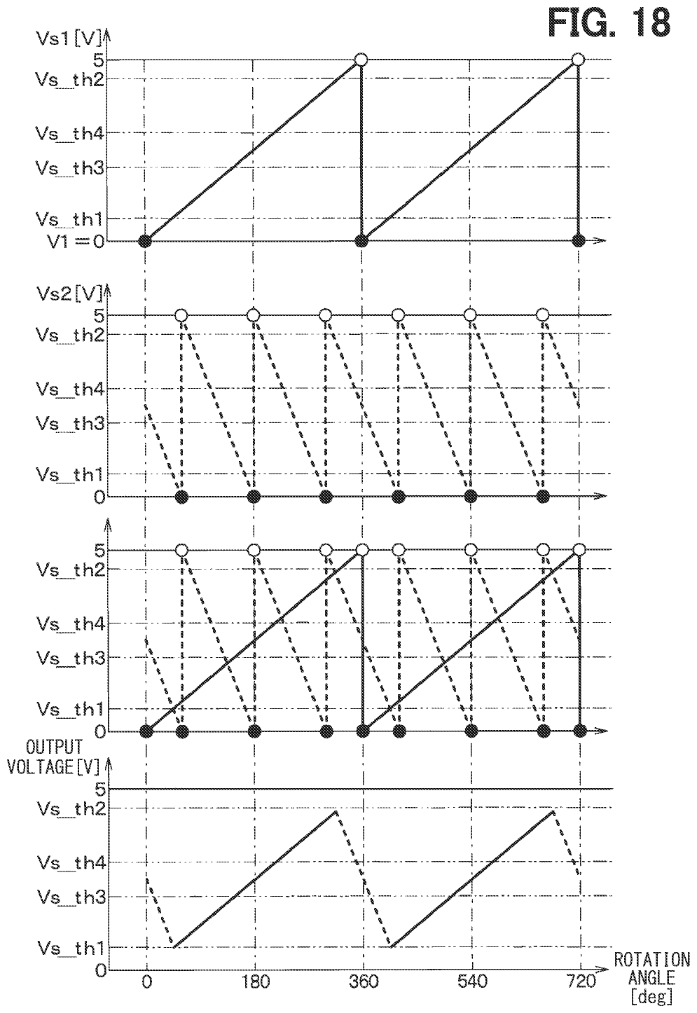

In the embodiments described above, as illustrated in FIG. 7, the line obtained by plotting the first output voltage Vs1 with respect to the rotation angle θ during one cycle period and the line obtained by plotting the second output voltage Vs2 with respect to the rotation angle θ during two consecutive cycle periods cross each other, and the two points of intersection are generated. However, as illustrated in FIG. 18, it may also be possible that the line obtained by plotting the first output voltage Vs1 with respect to the rotation angle θ during one cycle period and the line obtained by plotting the second output voltage Vs2 with respect to the rotation angle θ during two consecutive cycle periods cross each other, and a plurality of points of intersection are generated. In this case, a minimum value of a voltage corresponding to one of the points of intersection is the first threshold Vs_th1. In addition, a maximum value of the voltage corresponding one of the points of intersection is the second threshold Vs_th2. Consequently, in a range of at least the first threshold Vs_th1 and at most the second threshold Vs_th2, the voltage output from the rotation angle detecting unit 30 has a value continuous at any rotation angle θ.

Alternatively, it may also be possible that a line obtained by plotting the second output voltage Vs2 with respect to the rotation angle θ during one cycle period and a line obtained by plotting the first output voltage Vs1 with respect to the rotation angle θ during a plurality of cycle periods cross each other, and a plurality of points of intersection are generated. In this case also, a minimum value of a voltage corresponding to one of the points of intersection is the first threshold Vs_th1. In addition, a maximum value of a voltage corresponding to one of the points of intersection is the second threshold Vs_th2. Consequently, in the range of at least the first threshold Vs_th1 and at most the second threshold Vs_th2, the voltage output from the rotation angle detecting unit 30 has a value continuous at any rotation angle θ.

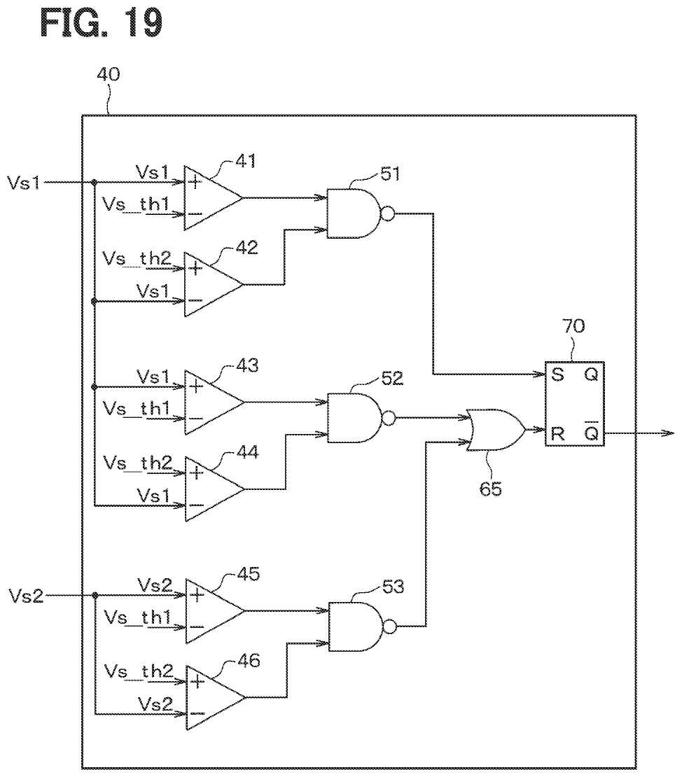

In the embodiments described above, the third threshold Vs_th3 is set to a voltage larger than the first threshold Vs_th1 and smaller than the fourth threshold Vs_th4 described later. The fourth threshold Vs_th4 is set to a voltage larger than the third threshold Vs_th3 and smaller than the second threshold Vs_th2. Meanwhile, the third threshold Vs_th3 may also be set to the same voltage as that of the first threshold Vs_th1. In addition, the fourth threshold Vs_th4 may also be set to the same voltage as that of the second threshold Vs_th2. There is also a case where the third threshold Vs_th3 is set to the same voltage as that of the first threshold Vs_th1 and the fourth threshold Vs_th4 is set to the same voltage as that of the second threshold Vs_th2. In that case, the selector unit 40 configured to include the analog circuit as the main component has, e.g., an OR circuit 65, instead of the AND circuit 60, as illustrated in FIG. 19.

It may also be possible that the embodiments described above are appropriately combined with each other.

What is claimed is:

1. A rotation angle detecting device comprising:
a detecting unit configured to
output a first output value that varies with a rotation angle of a rotary body in a first cycle having, as one cycle period, a predetermined range of the rotation angle and
output a second output value that varies with the rotation angle in a second cycle having, as one cycle period, another range of the rotation angle, which is different from that of the first cycle, a variation in the second output value being different from a variation in the first output value in a positive/negative sign, a magnitude relationship between the first output value and the second output value changing with a variation in the rotation angle at a plurality of rotation angles during the one cycle period of the first cycle;
a selector unit configured to select, from between the first output value and the second output value, a value, which is at least a first threshold corresponding to a minimum value of values of the first output value corresponding to the plurality of rotation angles, and which is at most a second threshold corresponding to a maximum value of the values of the first output value corresponding to the plurality of rotation angles; and
a computing unit configured to compute, based on the value selected by the selector unit, a value related to the rotation angle.

2. The rotation angle detecting device according to claim 1, wherein,
when either one of the first output value and the second output value is selected and when the first output value and the second output value are at least the first threshold and at most the second threshold, the selector unit is configured to maintain selection of the value selected by the selector unit.

3. The rotation angle detecting device according to claim 2, wherein,
when a positive/negative sign of the variation in the first output value is same as a positive/negative sign of the variation in the second output value due to switching of the first output value from a maximum value of the first output value to a minimum value of the first output value or due to switching of the first output value from a minimum value of the first output value to a maximum value of the first output value, the first output value and the second output value, when the magnitude relationship between the first output value and the second output value changes, are at least the first threshold and at most the second threshold.

4. A rotation angle detecting device comprising:
a detecting circuit configured to
output a first output value that varies with a rotation angle of a rotary body in a first cycle having, as one cycle period, a predetermined range of the rotation angle and
output a second output value that varies with the rotation angle in a second cycle having, as one cycle period, another range of the rotation angle, which is different from that of the first cycle, a variation in the second output value being different from a variation in the first output value in a positive/negative sign, a magnitude relationship between the first output value and the second output value changing with a variation in the rotation angle at a plurality of rotation angles during the one cycle period of the first cycle;
a selector circuit configured to select, from between the first output value and the second output value, a value, which is at least a first threshold corresponding to a minimum value of values of the first output value corresponding to the plurality of rotation angles, and which is at most a second threshold corresponding to a maximum value of the values of the first output value corresponding to the plurality of rotation angles; and
a computing circuit configured to compute, based on the value selected by the selector circuit, a value related to the rotation angle.
